(19) United States
(12) Patent Application Publication
(10) Pub. No.: US 2011/0229747 A1
(43) Pub. Date: Sep. 22, 2011

(54) SECONDARY BATTERY CELL

(76) Inventors: Takayuki Mitani, Hitachinaka-shi (JP); Katsunori Suzuki, Nabari-shi (JP)

(21) Appl. No.: 13/029,784

(22) Filed: Feb. 17, 2011

(30) Foreign Application Priority Data
Mar. 18, 2010 (JP) 2010-062652

(51) Int. Cl. H01M 10/36

(52) U.S. Cl. 429/94

(57) ABSTRACT

The secondary battery cell according to the present invention includes a cylindrical winding core for winding the positive electrode and the negative electrode. This winding core has a hollow portion which pierces through the winding core coaxially from one end of the cylindrical winding core to the other end. The cross section of one side of the hollow portion is larger than that of the other end, so that a welding electrode rod is easily inserted from the side of the winding core with larger cross section of the hollow portion, and that the position of the welding electrode rod is well defined by the narrower hollow portion. The side of the winding core with larger cross section of the hollow portion is used for fitting a drive shaft of winding device.

### INCORPORATION BY REFERENCE

The disclosure of the following priority application is herein incorporated by reference: Japanese Patent Application No. 2010-062652, filed Mar. 18, 2010.

### BACKGROUND OF THE INVENTION

1. Field of the Invention

The present invention relates to a secondary battery cell.

2. Description of Related Art

In a secondary battery cell, of which a lithium secondary battery cell or the like is representative, an electrode group is constructed by winding a positive electrode upon which a positive electrode mixture is formed and a negative electrode upon which a negative electrode mixture is formed upon a winding core or an axial core (“winding core” will be used as a generic term for both of these) with separators being interleaved between them. Such a winding core has a cylindrical hollow portion having a central axis along its axial direction. The winding core is manufactured by laying the positive electrode, the negative electrode, and the separators upon one another upon the outer periphery of the winding core, and by then winding them up on the winding core. An example of such a structure in which a positive electrode, a negative electrode, and separators are wound upon an axis is disclosed in Japanese Laid-Open Patent Publication H09-92335.

A positive electrode current collecting member is arranged at one end of the winding core of the electrode group in its axial direction, and a negative electrode current collecting member is arranged at the other end of the winding core of the electrode group in its axial direction. A positive electrode is connected to the positive electrode current collecting member and a negative electrode is connected to the negative electrode current collecting member, and thereby an electricity storage unit is constructed. This electric storage unit and an electrolyte are contained within a battery cell casing, and the positive electrode current collecting member is connected to one output terminal, while the negative electrode current collecting member is connected to another output terminal.

### SUMMARY OF THE INVENTION

For manufacturing the electrode group by superimposing the positive electrode, the negative electrode, and the separators and winding them upon the winding core, the method has been considered of rotating the winding core by fitting a drive shaft of a winding device into the hollow portion of the winding core. If this method is employed, it is necessary to make the diameter of the hollow portion of the winding core somewhat large, in order to perform the winding with the winding device while applying an appropriate tension to the positive electrode, the negative electrode, and the separators that are to be wound upon the winding core.

On the other hand, it is more efficient for the diameter of a welding electrode rod that is used for welding an electrode current collecting member to the battery cell casing to be small. Due to this, in the prior art, a considerably large clearance has been provided between the hollow portion of the winding core and the welding electrode rod, and sometimes faults in the welding occur due to deviation of the position of the welded portion or due to partial contact that can be ascribed to inclination of the welding electrode rod. Thus, the object of the present invention is to provide a secondary battery that can reduce the occurrence of faults in the electrical connections between the positive current collection portion or the negative current collection portion and the output terminals.

The secondary battery cell according to the present invention includes an electricity storage unit that includes a winding core having a hollow portion pierced in an axial direction along its central portion, a positive electrode and a negative electrode that are wound around the outer circumferential surface of the winding core, and an electrolyte, and a battery cell container within which the electricity storage unit is contained; and the cross sectional shape of the hollow portion of the winding core orthogonal to its axis is larger at one position along that axis than at another position along that axis.

According to the 1st aspect of the present invention, a secondary battery cell comprises: an electricity storage unit that comprises a winding core having a hollow portion pierced along its central portion in an axial direction, a positive electrode and a negative electrode that are wound around the outer circumferential surface of the winding core, an electrolyte, a positive current collecting member and a negative current collecting member; and a battery cell container within which the electricity storage unit is contained; and wherein the cross sectional shape of the hollow portion of the winding core orthogonal to its axis is larger at one side along that axis than at another side along that axis.

According to the 2nd aspect of the present invention, a secondary battery cell comprising an electricity storage unit including a winding core having a hollow portion pierced along its central portion in an axial direction, a positive electrode and a negative electrode and a separator between the positive electrode and the negative electrode that are wound around of the winding core on its outer circumferential surface, and a positive current collecting member provided on one side of the winding core and a negative current collecting member provided on another side the winding core in its axial direction and respectively connected to the positive electrode or to the negative electrode, and a battery cell container that contains the electricity storage unit; and wherein the positive current collecting member and the negative current collecting member are welded to the battery cell container directly or indirectly via some other member and thereby electrically connected thereto; and the hollow portion of the winding core has a larger cross section orthogonal to the axial direction of the winding core at its welded side where either the positive current collecting member or the negative current collecting member is welded than at another side where neither the negative current collecting member nor the positive current collecting member is welded.

According to the 3rd aspect of the present invention, in a secondary battery cell according to the 1st or 2nd aspect, it is preferred that the cross section of the hollow portion of the winding core orthogonal to its axial direction at the one side is larger than that at the another side; and a joining portion is provided that smoothly joins between the one side of the hollow portion of the winding core and the another side thereof.

According to the 4th aspect of the present invention, in a secondary battery cell according to the 3rd aspect, it is preferred that the cross section of the hollow portion of the winding core orthogonal to its axial direction, at the one side of the hollow portion of the winding core, has a shape including a rectilinear portion as at least a portion thereof.

According to the 5th aspect of the present invention, in a secondary battery cell according to the 3rd aspect, it is preferred that the battery cell container comprises a cell casing, which has a cylindrical shape with an opening at one end and a bottom at the other end, and a lid; the cell casing is assumed to be a negative electrode; the electricity storage unit is cylindrical; the electricity storage unit has a positive lead that is provided nearer to the lid of the battery cell container, and a negative lead that is provide nearer to the bottom of the cell casing of the battery cell container; the cross section of the hollow portion of the winding core orthogonal to its axial direction nearer to the lid is larger than the cross section of the hollow portion of the winding core orthogonal to its axis nearer to the bottom of the cell casing; the positive current collecting member and the negative current collecting member are provided to the winding core respectively near the lid side of the winding core and near the bottom side of the cell casing; and the positive current collecting member on the lid side has a fixing portion, and the positive current collecting member on the lid side is fixed to the winding core by the fixing portion being fitted into the hollow portion of the winding core at the lid side.

According to the 6th aspect of the present invention, in a secondary battery cell according to the 5th aspect, it is preferred that the negative current collecting member near the bottom side of the cell casing has a fixing portion, and the negative current collecting member is fixed to the winding core at the bottom side of the cell casing by the fixing portion being fitted to the winding core on its bottom end portion external circumference.

### BRIEF DESCRIPTION OF THE DRAWINGS

FIG. 1 is an enlarged sectional view showing an embodiment of the present invention;

FIG. 2 is an exploded perspective view of the secondary battery cell shown in FIG. 1;

FIG. 3 is a perspective view that shows the details of an electrode group of FIG. 1 in a partly unwound state with a portion thereof being cut away;

FIG. 4 is an enlarged sectional view showing the details of a first embodiment of a winding core of the secondary battery cell shown in FIG. 1, in a state with a portion thereof cut away along its axial direction by two mutually orthogonal planes that contain its axis;

FIG. 5 is an enlarged sectional view of the FIG. 4 structure taken in a plane which is orthogonal to the axial direction and includes the line V-V;

FIG. 6 is an enlarged sectional view of the FIG. 4 structure taken in a plane which is orthogonal to the axial direction and includes the line VI-VI;

FIG. 7 is an enlarged sectional view of the FIG. 4 structure taken in a plane which is orthogonal to the axial direction and includes the line VII-VII;

FIG. 8 is a perspective view for explanation of a method of manufacture for the electrode group of the secondary battery cell shown in FIG. 1;

FIG. 9 is an enlarged sectional view for explanation of inserting a welding electrode rod for welding the electrode performed during the manufacture of the secondary battery cell shown in FIG. 1;

FIG. 10 is an enlarged perspective view for explanation of a state that the welding electrode rod is inserted to the end to touch the electrode, following the state shown in FIG. 9;

FIG. 11 is an enlarged sectional view showing the details of a second embodiment of the winding core of the secondary battery cell according to the present invention, in a state with a portion thereof cut away along its axial direction by two mutually orthogonal planes that contain its axis;

FIG. 12 is an enlarged sectional view of the FIG. 11 structure taken in a plane which is orthogonal to the axial direction and includes the line XII-XII;

FIG. 13 is an enlarged sectional view of the FIG. 11 structure taken in a plane which is orthogonal to the axial direction and includes the line XIII-XIII;

FIG. 14 is an enlarged sectional view of the FIG. 11 structure taken in a plane which is orthogonal to the axial direction and includes the line XIV-XIV;

FIG. 15 is an enlarged sectional view showing the details of a third embodiment of the winding core of the secondary battery cell according to the present invention, in a state with a portion thereof cut away along its axial direction by two mutually orthogonal planes that contain its axis;

FIG. 16 is an enlarged sectional view of the FIG. 15 structure taken in a plane which is orthogonal to the axial direction and includes the line XVI-XVI;

FIG. 17 is an enlarged sectional view of the FIG. 15 structure taken in a plane which is orthogonal to the axial direction and includes defined by the lines XVII-XVII;

FIG. 18 is an enlarged sectional view of the FIG. 15 structure taken in a plane which is orthogonal to the axial direction and includes the line XVIII-XVIII;

FIG. 19 is an enlarged sectional view showing the details of a fourth embodiment of the winding core of the secondary battery cell according to the present invention, in a state with a portion thereof cut away along its axial direction by two mutually orthogonal planes that contain its axis;

FIG. 20 is an enlarged sectional view showing the details of a fifth embodiment of the winding core of the secondary battery cell according to the present invention, in a state with a portion thereof cut away along its axial direction by two mutually orthogonal planes that contain its axis;

FIG. 21 is an enlarged sectional view showing the details of a sixth embodiment of the winding core of the secondary battery cell according to the present invention, in a state with a portion thereof cut away along its axial direction by two mutually orthogonal planes that contain its axis; and

FIG. 22 is an enlarged plan view of FIG. 1 as seen from above.

### DESCRIPTION OF THE PREFERRED EMBODIMENTS

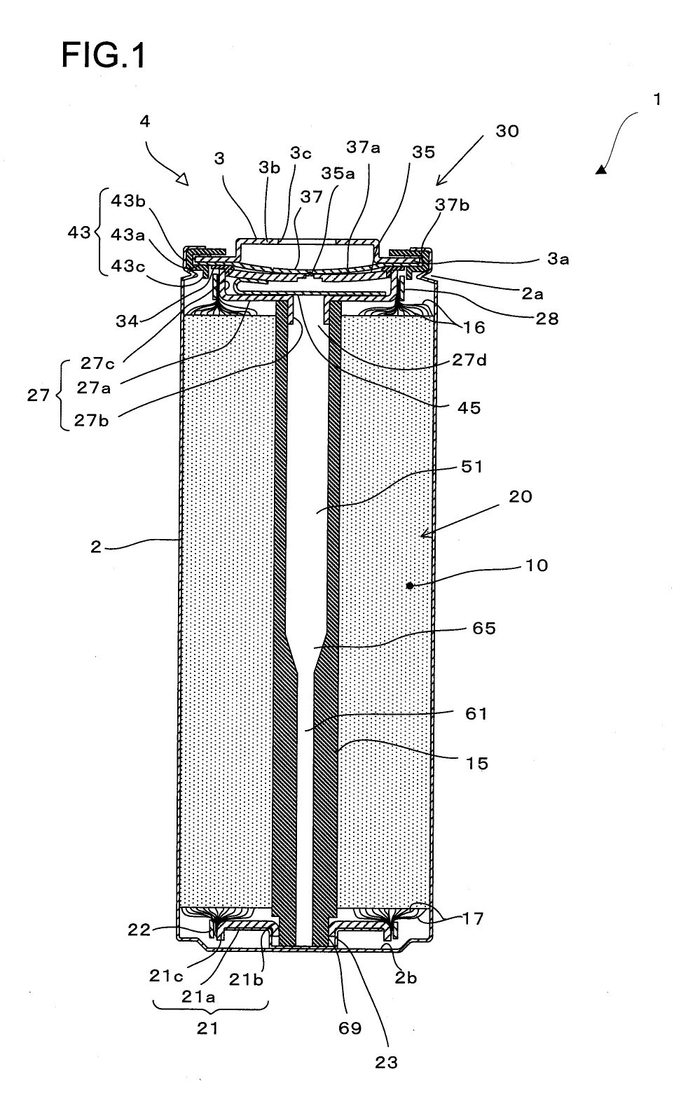

The various embodiments explained below solve various problems whose solution is desired in relation to manufacturing a secondary battery cell, in particular a lithium ion secondary battery cell. The object and effect described briefly above relate to one among various problems that it is desirable to solve in connection with manufacturing such a lithium ion secondary battery cell as described above as a manufactured product, and the following embodiments also solve various other problems than those described above briefly related to the object and effect of the invention. The principal problems among those solved by the various embodiments explained subsequently in this specification are enumerated below. In addition thereto, solutions for various other problems that occur will be explained during the explanation of the various embodiments. It is to be noted that the reference numbers appearing in the following enumerated problems being solved by the present invention are shown in the FIGS. 1, 2, 3, 9, 10.

—Enhancement of Reliability—

1. In the embodiments described below, it is supposed that a cylindrical battery case 2 is used as a container, and that an electrode group 10 formed by winding a positive electrode 11 and a negative electrode 12 around a winding core 15 has a cylindrical shape. With this type of winding structure, particularly in the case of a lithium ion secondary battery cell, despite that the thickness of the electrode group is varied according to the charged state, the stresses caused by such a thickness change become uniform within the battery cell, and this is linked to enhancement of the reliability.

2. The winding core 15 upon which the electrode group 10 is to be wound up is made as hollow, and the cross section of its hollow shape in a plane orthogonal to its axis near to one of its ends is made to be larger than the cross section of its hollow shape in a plane orthogonal to its axis near to the other of its ends. Due to this, it is possible to utilize this hollow portion near to that one of its ends for transmission of rotational torque to the winding core 15 for winding up the electrode group 10 thereupon. By doing this, it becomes simple and easy to control the rotational torque applied to the winding core 15 for winding up the electrode group 10, and it is possible to control the tension applied to the electrode group 10 in an appropriate manner. Therefore the reliability of the resulting lithium ion secondary battery cell is enhanced. Moreover, this is linked to improvement of its operational characteristics.

3. The hollow portion near the end of the winding core where the cross section is smaller may be utilized for guiding the welding electrode rod 73 in order to perform welding, so that it is possible to enhance the reliability of the welded portion. Due to this, it is possible to enhance the reliability of the lithium ion secondary battery cell as a whole.

—Enhancement of Productivity—

4. By combining the solutions of the problems explained in 2 and 3 above, it is not only possible to enhance the reliability of the lithium ion secondary battery cell, but also to enhance the productivity of the process for manufacture thereof.

—Implementation of Compactness—

5. In the embodiments described below, one of the current collecting members for the positive electrode or the negative electrode may be held by taking advantage of the hollow portion of the winding core that has the larger cross sectional shape. With this structure, the support construction for the current collecting member is simplified, and, as a result, it becomes possible to make it more compact. In other words, the proportion of the volume of the electrode group 10, which keeps electrical power, against the total volume of this lithium ion secondary battery cell is increased.

6. With the structure described in 5. above, the simultaneous effect is also obtained that the distance between the wound-up electrode group 10 and this one of the current collecting members is shortened, and this means that the advantageous effect is obtained of it being possible to shorten the lengths of the positive leads 16 or of the negative leads 17. In addition to the beneficial effect according to this construction of making the resulting assembly more compact, this is also linked with improvement of the characteristics of the lithium ion secondary battery cell.

7. In the embodiments described below, the current collecting members for the positive electrode or the negative electrode is held at the end of the portion of the winding core 15 where the hollow portion has smaller cross section. Since the cross sectional shape of the hollow portion here is smaller, the thickness of this other end portion of the winding core 15 is increased, and this makes it possible to process the external circumference of the winding core 15 (for example, by forming a portion of reduced size thereupon). By providing a structure for supporting the current collecting member by utilizing the external circumference of the winding core 15 in this manner, it is possible to implement a simplified structure for fitting the current collecting member at this end portion of the winding core 15, and this has an advantageous effect in connection with making the lithium ion secondary battery cell more compact.

8. The structure described in 7. above also serves for shortening the distance between the wound up electrode group 10 and the other one of the current collecting members, that provides the advantageous effect of making it possible to shorten the lengths of the positive leads 16 or of the negative leads 17. In addition to the beneficial effect of making the construction more compact in this manner, also there is a linkage with improvement of the characteristics of this lithium ion secondary battery cell.

### Embodiment 1

In the following, as an embodiment of a secondary battery cell according to the present invention, an embodiment of a lithium ion secondary battery cell will be explained with reference to the drawings.

—Construction of the Lithium Ion Secondary Battery Cell—

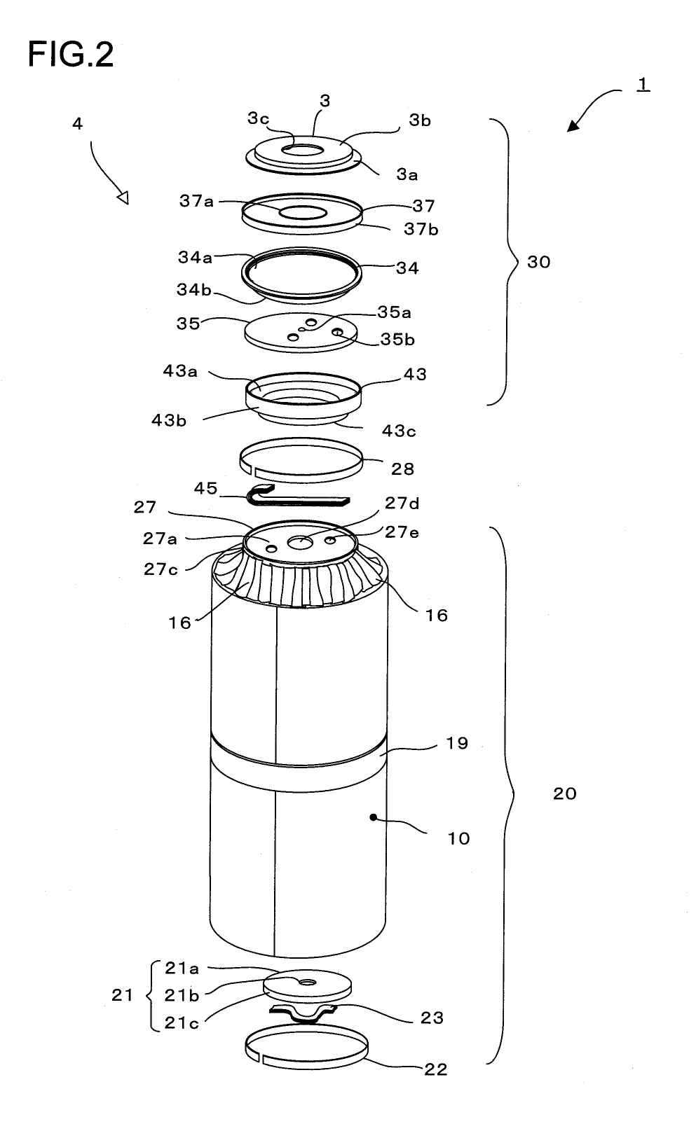

FIG. 1 is an enlarged sectional view showing an embodiment of a lithium ion secondary battery cell according to the present invention, and FIG. 2 is an exploded perspective view of the lithium ion secondary battery cell shown in FIG. 1. The present invention can be applied to a secondary battery cell whose external appearance is square in shape, as well as to a secondary battery cell whose external appearance is cylindrical in shape. In particular, the present invention is better adapted for application to a lithium ion secondary battery cell whose external appearance is cylindrical in shape. Accordingly, in the following, a lithium ion secondary battery whose external appearance is cylindrical will be explained by way of example.

This cylindrical secondary battery cell 1 may, for example, have dimensions of 40 mm diameter and 100 mm height. In this cylindrical secondary battery cell 1, various structural members for generation of electricity that will be explained below are contained in the interior of a battery cell container 4 that includes a cylindrical battery cell casing 2 that is open at the top and has a bottom, and a hat shaped lid 3 that closes the upper portion of the battery cell casing 2. A groove 2a is formed upon this cylindrical battery cell casing 2 with a bottom, so as to project inward towards the central axis of the battery cell casing at its upper end portion, near the aperture thereof.

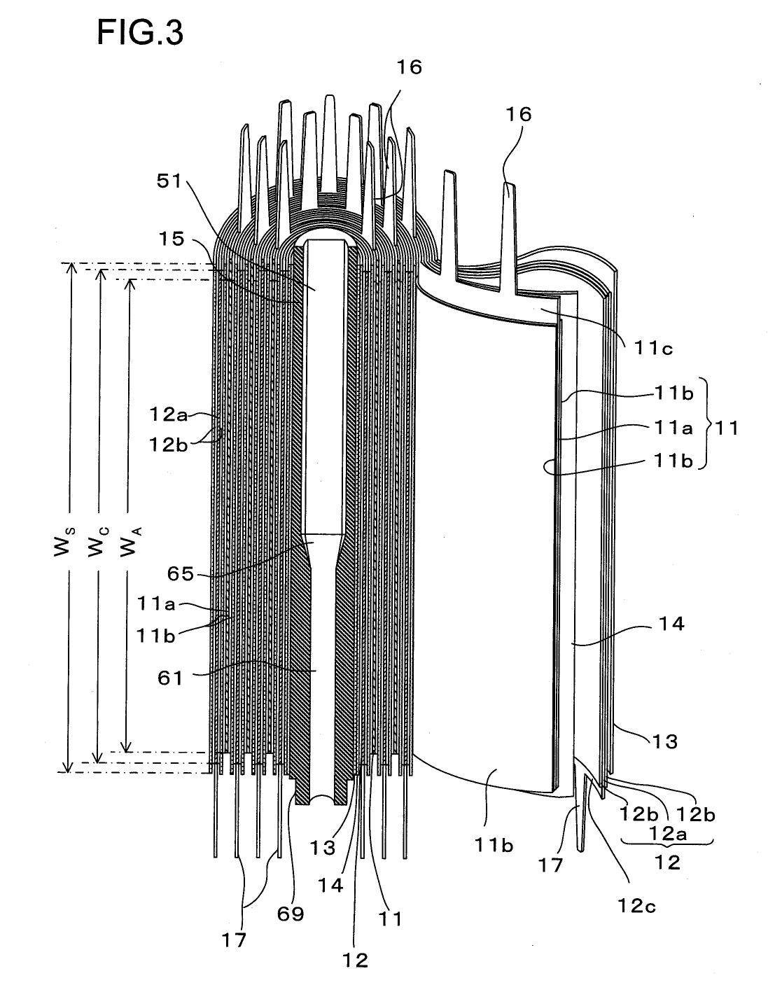

The electrode group 10 has a winding core 15 at its central portion, and a positive electrode and a negative electrode are wound around the external peripheral surface of this winding core 15. FIG. 3 shows the details of the construction of this electrode group 10, and is a perspective view showing the electrode group 10 in a partly unwrapped state with a portion thereof cut away. As shown in FIG. 3, this electrode group 10 has a construction in which a negative electrode 12, a positive electrode 11, and first and second separators 13 and 14 are wound around the external peripheral surface of the winding core 15. It should be noted that the winding core 15 is made of such a material that isolates electrically between the positive electrode current collecting member 27 and the negative electrode current collecting member 21, and that also keeps the axial rigidity of the battery cell. In the present embodiment, for example, as the material for the winding core 15, a glass-fiber reinforced polypropylene is employed.

In this case, the negative electrode 12, the first separator 13, the positive electrode 11, and the second separator 14 are laminated and wound upon the winding core 15 in order. The first separator 13 and the second separator 14 are wound several times (in FIG. 3, once) inside the innermost turn of the negative electrode 12. And the outermost turn is the negative electrode 12 and the first separator 13 that is wound around its external circumference. This outermost turn of the first separator 13 is held by adhesive tape 19 (refer to FIG. 2).

The positive electrode 11 may, for example, include a positive electrode sheet 11a made from aluminum foil of thickness around 20 μm and having an elongated shape, and a positive electrode processed portion consisting of layers of positive electrode mixture 11b on both sides of this positive electrode sheet 11a which layers are formed by applying the electrode mixture on the positive electrode sheet 11a. The upper side edge of the positive electrode sheet 11a is a positive electrode mixture uncovered portion 11c to which the positive electrode mixture is not applied so that the aluminum foil is exposed. A large number of positive leads 16 are formed integrally upon this positive electrode mixture uncovered portion 11c at regular intervals, and project upwards along the axis of the winding core 15.

The positive electrode mixture includes an active positive electrode material, a positive electrode conductive material, and a positive electrode binder. Desirably, the active positive electrode material is lithium metal oxide or a lithium transitional metal oxide. As examples, lithium cobalt oxide, lithium manganese oxide, lithium nickel oxide, or a lithium compound metal oxide (that includes two or more sorts of lithium metal oxides selected from the lithium metal oxides based on cobalt, nickel, and manganese) or the like may be cited. It should be noted that the above mentioned compound lithium metal oxide including transitional metal components may also be used as a conductive positive electrode material, since it has a conductivity. And the positive electrode conductive material is not to be considered as being particularly limited, provided that it can assist with the transmission of electrons generated by an occlusion/emission reaction of lithium included in the positive electrode mixture to the positive electrode.

The positive electrode binder is not to be considered as being particularly limited, provided that it is capable of binding together the active positive electrode material and the positive electrode conductive material, and also of binding the positive electrode mixture to the positive electrode sheet 11a, and provided that it is not greatly deteriorated by contact with the non-aqueous electrolyte. Examples that may be cited of such a suitable positive electrode binder are polyvinylidene fluoride (PVDF) and fluorine rubber and so on. The method of forming the positive electrode mixture layer 11b is not to be considered as being particularly limited, provided that it is a method that is capable of forming a layer of the positive electrode mixture upon the positive electrode sheet 11a. As one example of a method for forming the positive electrode mixture layer 11b upon the positive electrode sheet 11a, the method of applying upon the positive electrode sheet 11a a solution in which the substances of which the positive electrode mixture is to be made are dispersed may be cited. A positive electrode mixture layer 11b having excellent characteristics may be obtained by manufacture according to this type of method.

As methods for application of the positive electrode mixture upon the positive electrode sheet 11a, a roll coating method or a slit die coating method or the like may be cited. As examples of the solvent for dispersal of the positive electrode mixture as a solution, N-methyl-pyrrolidone (NMP) or water or the like may be added, and the mixture may be kneaded into a slurry, may be applied uniformly to both sides of aluminum foil of thickness 20 μm, and this material may be cut out after having been dried. For example, the thickness to which the positive electrode mixture is applied may be around 40 μm on each side. When cutting out the positive electrode sheet 11a, the positive leads 16 are formed integrally therewith. The lengths of all of the positive leads 16 are almost the same.

And the negative electrode 12 may, for example, include a negative electrode sheet 12a made from copper foil of thickness around 10 μm and having an elongated shape, and a negative electrode processed portion consisting of layers of negative electrode mixture 12b on both sides of this negative electrode sheet 12a are formed by applying the electrode mixture on the negative electrode sheet 12a. The lower side edge of the negative electrode sheet 12a is a negative electrode mixture uncovered portion 12c to which the negative electrode mixture is not applied so that the copper foil is exposed. A large number of negative leads 17 are formed integrally upon this negative electrode mixture uncovered portion 12c at regular intervals, and project downwards along the axis of the winding core 15, i.e. in the opposite direction to that of the positive leads 16.

The negative electrode mixture includes an active negative electrode material, a negative electrode binder, and a thickener. It will be acceptable for the negative electrode mixture to include acetylene black or the like as the negative electrode conductive material. It is desirable to utilize graphitic carbon as the active negative electrode material, and it is particularly desirable to utilize artificial graphite. By using graphitic carbon, it is possible to manufacture a lithium ion secondary battery cell that is aimed at use in a plug-in hybrid automobile or in an electric automobile, for which high capacity is demanded. The method of forming the layer of negative electrode mixture 12b is not to be considered as being particularly limited, provided that it is a method that is capable of forming the negative electrode mixture upon the negative electrode sheet 12a. However, among these, by employing the method described below, it is possible to obtain a negative electrode mixture that has excellent characteristics. As one example of a method for forming the negative electrode mixture layer 12b upon the negative electrode sheet 12a, the method of applying a solution in which the substances of which the negative electrode mixture is made are dispersed upon the negative electrode sheet 12a may be cited. And, as methods for application, a roll coating method or a slit die coating method or the like may be cited.

As examples of the method for applying the negative electrode mixture to the negative electrode sheet 12a, N-methyl-pyrrolidone (NMP) or water or the like may be added to the negative electrode mixture as a dispersal solvent, and the mixture may be kneaded into a slurry, may be applied uniformly to both sides of rolled copper foil of thickness 10 μM, and this material may be cut out after having been dried. For example, the thickness to which the negative electrode mixture is applied may be around 40 μm on each side. When cutting out the negative electrode sheet 12a, the negative leads 17 are formed integrally therewith. The lengths of all of the negative leads 17 are almost the same.

With the widths of the first separator and the second separator being termed W_{S}, the width of the layer of negative electrode mixture 12b formed on the negative electrode sheet 12a being termed W_{C}, and the width of the layer of positive electrode mixture 11b formed on the negative electrode sheet 11a being termed W_{A}, these are formed so as to satisfy the following equation:

W_{S}>W_{C}>W_{A} (refer to FIG. 3)

In other words, the width W_{C} of the layer of negative electrode mixture 12b is always greater than the width W_{A} of the layer of positive electrode mixture 11b. This is done because, in the case of a lithium ion secondary battery cell, as the lithium that is the active positive electrode material is ionized and penetrates the separator, if the lithium is deposited upon the negative electrode sheet 12a where the layer of active negative electrode material on the negative electrode side is not formed and the negative electrode sheet 12a is exposed, then this will generate an internal short circuit. The separators 13 and 14 are perforated films made from, for example, polyethylene or the like and of thickness 40 μm.

As shown in FIGS. 1, 3 and 4, the winding core 15 has a hollow portion pierced along its axial direction, and its external shape is cylindrical. The structure of this winding core 15 is one of the special characteristics of the secondary battery cell according to the present invention, and its details will be described hereinafter; here, only a summary thereof will be explained.

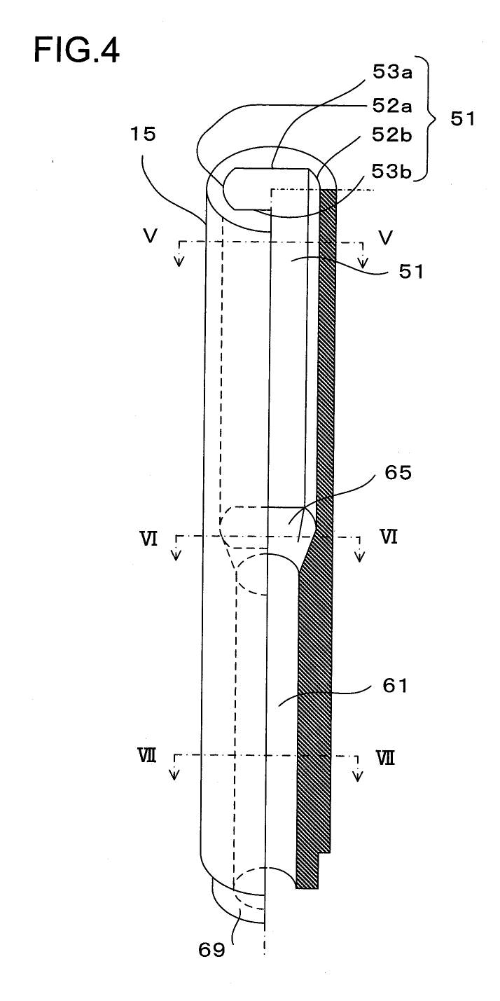

The hollow portion of the winding core 15 has a casing top end hollow portion 51 that is positioned at its upper end along its axial direction (the vertical direction in FIG. 4), and a casing bottom end hollow portion 61 that is positioned at its lower end, and, in a plane section orthogonal to the axis of winding core 15, the cross sectional size of the casing top end hollow portion 51 is larger than the cross sectional size of the casing bottom end hollow portion 61. In this embodiment, the casing top end hollow portion 51 corresponds to approximately the upper half thereof along its axial direction, and the casing bottom end hollow portion 61 similarly corresponds to approximately the lower half thereof along its axial direction. Moreover, the casing top end hollow portion 51 has a cross section of approximately the same size all along its length, and similarly the casing bottom end hollow portion 61 has a cross section of approximately the same size all along its length. Here, the casing top end corresponds to the open end of the cylindrical battery cell casing 2 having a bottom, and the casing bottom end corresponds to the bottom of this cylindrical battery cell casing 2 having a bottom. At the portion that connects the casing top end hollow portion 51 and the casing bottom end hollow portion 61, a shape is formed whose inner surface connects smoothly from the casing top end hollow portion 51 whose cross sectional size is larger to the casing bottom end hollow portion 61 whose cross sectional size is smaller. Furthermore, the cross section of the casing bottom end hollow portion 61 is circular, and, as described below, in addition to the fact that a circle is a shape that is excellent for guiding a welding electrode rod, this is also extremely beneficial from the point of view of productivity.

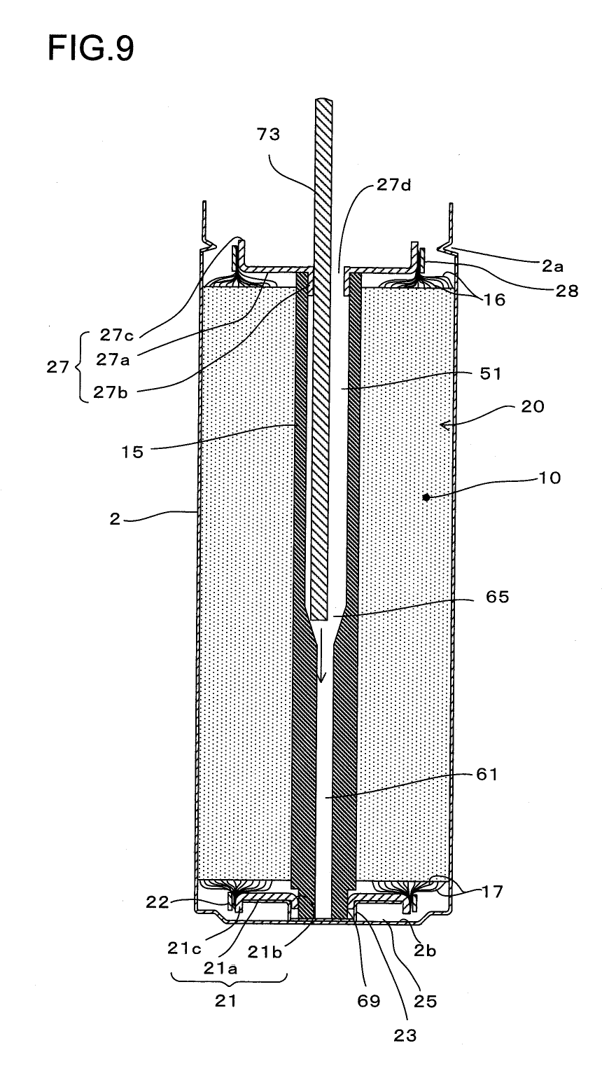

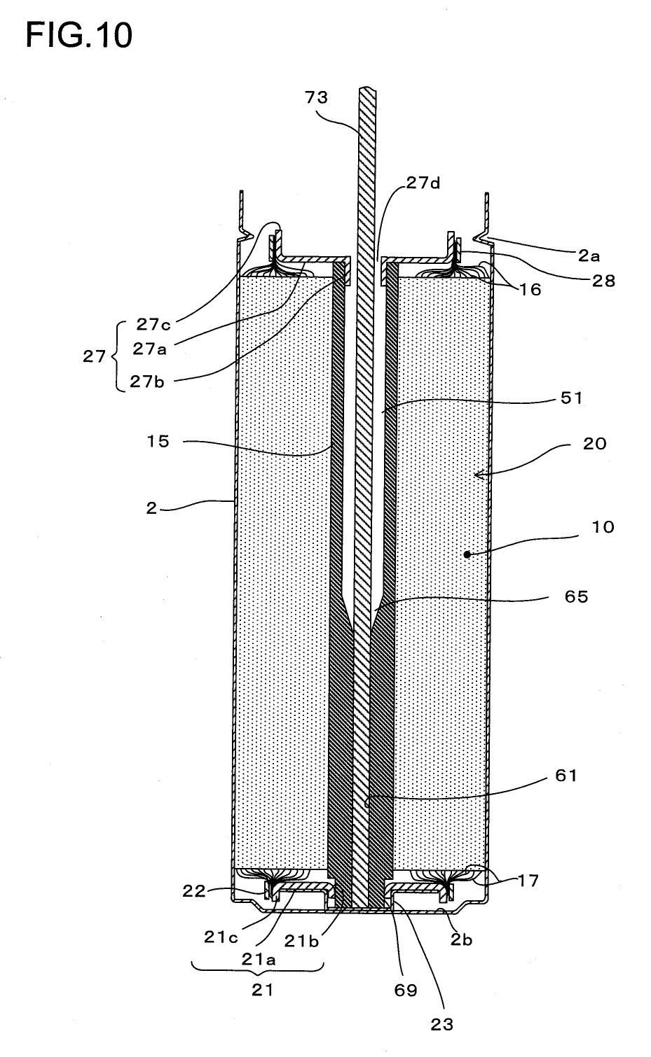

Moreover, since the inner surface of the hollow portion that connects from the casing top end hollow portion 51 whose cross sectional size is larger to the casing bottom end hollow portion 61 whose cross sectional size is smaller is formed as this smooth connection shape, accordingly the insertion of a welding electrode rod 73 for welding, as will be explained hereinafter with reference to FIGS. 9 and 10, can be performed very smoothly, and this is related to enhancement of the ease of working. Even further, the reliability of the welding task is greatly enhanced, since this structure operates to help with positional determination of the welding electrode rod 73.

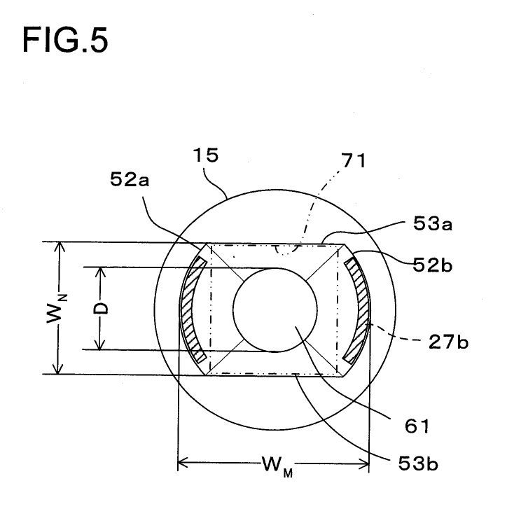

The positive electrode current collecting member 27 is, for example, made from aluminum, and includes a base portion 27a formed as a circular disk, a fitting portion 27b that projects towards the winding core 15 from the inner circumference of the base portion 27a and that is inserted into the inner surface of the winding core 15, and an upper cylinder portion 27c that projects towards the lid 3 at the outer peripheral edge of the base portion 27a. As seen in plan view, the fitting portion 27b of the positive electrode current collecting member 27 is shaped as a pair of circular arcs that are symmetric about the axis of the winding core 15 (see FIG. 5), and this fitting portion 27b fits into the upper end portion of the casing top end hollow portion 51 of the winding core 15. Moreover, an opening portion 27d is defined at the interior of this fitting portion 27b. This opening portion 27d serves as an entrance for insertion of a welding electrode rod, as will be described hereinafter. Moreover, apertures 27e (refer to FIG. 2) are formed in the base portion 27a of the positive electrode current collecting member 27. These apertures 27e have the functions of allowing injection of the electrolyte, and of venting gas that is generated inside the battery cell. The lid 3 that is connected to the positive electrode current collecting member 27 described above serves as one of the output terminals of this battery cell: electrical power stored in the battery cell can be extracted via this lid 3.

The positive leads 16 of the positive electrode sheet 11a are all welded to the upper cylinder portion 27c of the positive electrode current collecting member 27. In this case, as shown in FIG. 2, these positive leads 16 are overlapped when they are thus joined to the upper cylinder portion 27c of the positive electrode current collecting member 27. Each of the positive leads 16 is very thin, so that it is not possible for one of them to extract a large electrical current. Because of this, the large number of positive leads 16 are formed at predetermined intervals along the entire length of the upper side of the positive electrode sheet 11a, from the point where it starts to be wound upon the winding core 15 to the point where that winding ends.

Since the positive electrode current collecting member 27 is oxidized by the electrolyte, it is possible to enhance its reliability by making it from aluminum. When due to some type of processing the surface of non-oxidized aluminum is exposed, immediately a surface coating of oxidized aluminum is formed upon that surface, and it is possible to prevent further oxidization by the electrolyte due to this coating of aluminum oxide. Moreover, by making the positive electrode current collecting member 27 from aluminum, it becomes possible to weld the positive leads 16 of the positive electrode sheet 11a to it by ultrasonic welding or by spot welding or the like.

A stepped portion 69 whose outer diameter is smaller than the outer diameter of the winding core 15 is formed at the lower end portion of the winding core 15, and the negative electrode current collecting member 21 is fitted over this stepped portion 69. This negative electrode current collecting member 21 is, for example, made from copper, and is formed with a base portion 21a that is shaped as a circular disk, an opening portion 21b formed to be press fitted over the stepped portion 69 of the winding core 15, and an outer cylinder portion 21c that projects from the outer peripheral edge of the base portion 21 in the downward direction in the figures towards the bottom portion of the battery cell casing 2.

The negative leads 17 of the negative electrode sheet 12a are all welded to the outer cylinder portion of the negative electrode current collecting member 21 by ultrasonic welding or the like. Since each of the negative leads 17 is very thin so that it is not possible for one of them to extract a large electrical current, accordingly the large number of negative leads 17 are formed at predetermined intervals along the entire length of the lower side of the negative electrode sheet 12a, from the point where it starts to be wound upon the winding core 15 to the point where that winding ends. With this structure, it is possible to distribute the flow of electrical current approximately equally over all of the negative leads 17, and this is linked to enhancement of the reliability of this lithium ion secondary battery cell.

The negative leads 17 of the negative electrode sheet 12a and the annular pressure member 22 are welded to the external periphery of the outer cylinder portion of the negative electrode current collecting member 21. The large number of negative leads 17 are thickly layered over one another upon the external periphery of the outer cylinder portion 21c of the negative electrode current collecting member 21, are temporarily fixed there by the pressure member 22 being fitted around them, and are then welded in this state.

A negative electrode conducting lead 23 that is made from copper is welded to the lower surface of the negative electrode current collecting member 21. This negative electrode conducting lead 23 is welded to the battery cell casing 2 at the bottom portion of the casing 2. The battery cell casing 2 is made, for example, from carbon steel of thickness 0.5 mm, and its surface is nickel plated. By employing this type of material, it is possible to weld the negative electrode conducting lead 23 to the inner surface 2b of the bottom portion of the battery cell casing 2 by resistance welding or the like. The details of the welding method will be described hereinafter along with the details of the structure of the winding core 15. The battery cell casing 2 to which the negative electrode current collecting member 21 is connected as described above serves as the other output terminal of this battery cell, so that it becomes possible to output electrical power accumulated in this battery cell by employing the function of the above described lid 3 that serves as one output terminal and the function of the above described battery cell casing 2 that serves as the other output terminal.

The positive leads 16 of the positive electrode sheet 11a and an annular pressure member 28 are welded to the external peripheral surface of the upper cylinder portion 27c at one side of the positive electrode current collecting member 27 (at the upper side thereof as seen in the figure). The large number of positive leads 16 are layered over one another upon the external periphery of the upper cylinder portion 27c of the positive electrode current collecting member 27, and are temporarily fixed by winding the pressure member 28 around over them, and are then welded in this state.

By welding the large number of positive leads 16 to the positive electrode current collecting member 27, and by welding the large number of negative leads 17 to the negative electrode current collecting member 21, the positive electrode current collecting member 27, the negative electrode current collecting member 21, and the electrode group 10 are integrated together into one unit, so as to constitute the electricity storage unit 20 (refer to FIG. 2). However in FIG. 2, for the sake of convenience, the negative electrode current collecting member 21, the pressure member 22, and the negative electrode conducting lead 23 are shown as separated from the electricity storage unit 20.

Furthermore, one end of a flexible connection member 45 that includes a plurality of sheets of aluminum foil laminated together is joined by welding to the upper surface of the base portion 27a of the positive electrode current collecting member 27. By this connection member 45 being made from a plurality of sheets of aluminum foil laminated together and thus integrated, it is made to be capable of conducting a high electrical current, and moreover it is endowed with flexibility. In other words, while this connection member 45 needs to be given a certain thickness in order to be able to conduct a high electrical current, if it were to be made from a single metallic plate, then its rigidity would be very high, and its flexibility would be lost. Thus it is given adequate flexibility by laminating together a large number of sheets of aluminum foil whose individual thicknesses are very small. The thickness of the connection member may, for example, be 0.5 mm, and it may be made by laminating together 5 sheets of aluminum foil each having thickness of 0.1 mm.

A lid unit 30 is disposed above the upper cylinder portion 27c of the positive electrode current collecting member 27. This lid unit 30 includes a ring shaped insulation plate 34, a connection plate 35 that is fitted into an opening portion 34a provided in the insulation plate 34, a diaphragm 37 that is welded to the connection plate 35, and a lid 3 that is fixed by swaging to the diaphragm 37. The insulation plate 34 is made from an insulating resin material in the shape of a ring that has the circular opening portion 34a, and is mounted upon the upper cylinder portion 27c of the positive electrode current collecting member 27.

The insulation plate 34 has an opening portion 34a (refer to FIG. 2) and a side portion 34b that projects downward. The connection plate 35 fits into the opening portion 34a of the insulating plate 34. The other end portion of the connection member 45 is joined by welding to the lower surface of the connection plate 35. In this case, the connecting member 45 is curved into approximately a half circle at this other end portion, so that its surface that is welded to the positive electrode current collecting member 27 is the same surface as the one that is welded to the connection plate 35.

The connection plate 35 is made from aluminum alloy, and is almost entirely uniform except for its central portion, but that central portion is bent downwards to a somewhat lower position, so that the connection plate 35 is substantially formed in a dish-shape. This connection plate 35 may, for example, be around 1 mm thick. A projecting portion 35a made in the shape of a small dome is formed at the center of the connection plate 35, and a plurality of apertures 35b are formed around this central projecting portion 35a (refer to FIG. 2). These apertures 35b have the function of venting gas generated in the interior of the battery cell. Due to this, the security of this lithium ion secondary battery cell is enhanced.

The central projecting portion 35a of the connection plate 35 is joined to the central portion of the bottom surface of the diaphragm 37 by resistance welding or friction stir welding. The diaphragm 37 is made from aluminum alloy, and has a circular groove 37a centered upon its center portion. This groove 37a is formed by squashing the upper surface of the diaphragm 37 into a V-shape using an appropriate tool, so that the remaining portion is very thin. This diaphragm 37 is provided in order to enhance the security of this battery cell: when the internal pressure in the battery cell rises, at a first stage, the diaphragm 37 bends upwards so that its junction with the projecting portion 35a of the connection plate 35 breaks away and the diaphragm 37 separates from the connection plate 35, so that the electrical continuity between the diaphragm 37 and the connection plate 35 is interrupted. And at a second stage, if the internal pressure increases further, the groove 37a ruptures, and this provides the function of venting the gas internal to the battery cell.

The diaphragm 37 is fixed at its periphery to the periphery of the lid 3. As shown in FIG. 2, the diaphragm 37 has a side portion 37b at its periphery that, initially, projects vertically upwards towards the lid 3. The lid 3 is contained within this side portion 37b, and, by a swaging process, the side portion 37b is bent inwards towards the upper surface of the lid 3 and is fixed there.

The lid 3 is made from a ferrous material such as carbon steel or the like and is nickel plated, and is made in a hat shape that includes a circular disk shaped peripheral portion 3a that contacts the diaphragm 37 and a top portion 3b, and that projects upwards from this peripheral portion 3a. An opening portion 3c is formed in this top portion 3b. This opening portion 3c is for venting gas inside the battery cell to the exterior, if the diaphragm 37 has ruptured due to the pressure of gas generated internally to the battery cell. It should be understood that, if the lid 3 is made from a ferrous material, then, when this cylindrical secondary battery cell is to be connected in series with another cylindrical secondary battery cell of which cell casing 2 is also made from a ferrous material, it may be joined to those other cylindrical secondary battery cells by spot welding.

A gasket 43 is provided that covers the side portion 37b and the peripheral portion of the diaphragm 37. Initially, as shown in FIG. 2, this gasket 43 has a shape including an annular base portion 43a, an external peripheral wall portion 43b that is formed at the peripheral edge of the annular base portion 43a and projects almost vertically upwards towards the upper portion of the battery cell, and a cylinder portion 43c that is formed at the inner periphery of the base portion 43a and drops downwards almost vertically.

And, while the details thereof will be described hereinafter, swaging processing is performed by pressing or the like, so that the external peripheral wall portion 43b of the gasket 43 is folded together with the battery cell casing 2, and this causes the diaphragm 34 and the lid 3 to be pressed into contact along the axial direction by the base portion 43a and the external peripheral wall portion 43b. Due to this, the lid 3 and the diaphragm 37 are fixed to the battery cell casing 2 with the intervention of the gasket 43.

A predetermined amount of a non-aqueous electrolyte is injected into the interior of the battery cell casing 2. As an example, one substance that may desirably be used for this non-aqueous electrolyte is a lithium salt dissolved in a carbonate type solvent. Lithium hexafluorophosphate (LiPF6) or lithium tetrafluoroborate (LiBF6) or the like may be cited as examples of lithium salts. And ethylene carbonate (EC), dimethyl carbonate (DMC), propylene carbonate (PC), or methyl-ethyl carbonate (MEC), or mixtures of two or more solvents selected from the solvents described above, may be cited as examples of carbonate type solvents.

Next, the details of the winding core 15 of this secondary battery cell according to the present invention will be explained. FIG. 4 is an enlarged perspective view showing the winding core 15 with a portion thereof cut away along its axial direction by two planes at 90° to one another, each containing the axis of the winding core 15. However, for the sake of convenience of illustration, in contrast to the way the winding core 15 is shown in FIGS. 1 and 3, in FIG. 4, the scales of the winding core 15 in the directions at right angles to its axial direction are enlarged around twice as compared to its scale in the axial direction. Moreover, FIGS. 5, 6, and 7 are enlarged plan views of sections taken through FIG. 4 in planes which are respectively orthogonal to the axial direction and include the lines V-V, VI-VI, and VII-VII.

As shown in FIG. 4, the winding core 15 has the casing top end hollow portion 51 at its upper half portion in its axial direction (the vertical direction in the figure), and the casing bottom end hollow portion 61 at its lower half portion. As shown in FIG. 5, the casing top end hollow portion 51 has a barrel shaped cross sectional shape, defined by two curved surfaces 52a and 52b with cross sections of circular arcs whose central axes coincide with the axis of the winding core 15, and two parallel surfaces 53a and 53b which sandwich these two curved surfaces 52a and 52b. As shown in FIG. 5, if the width of the top end hollow portion 51 between these two opposing parallel surfaces 53a and 53b is termed W_{N}, and its width between the two opposing curved surfaces 52a and 52b is termed Wₘ, then the relationship W_{N}<Wₘ holds.

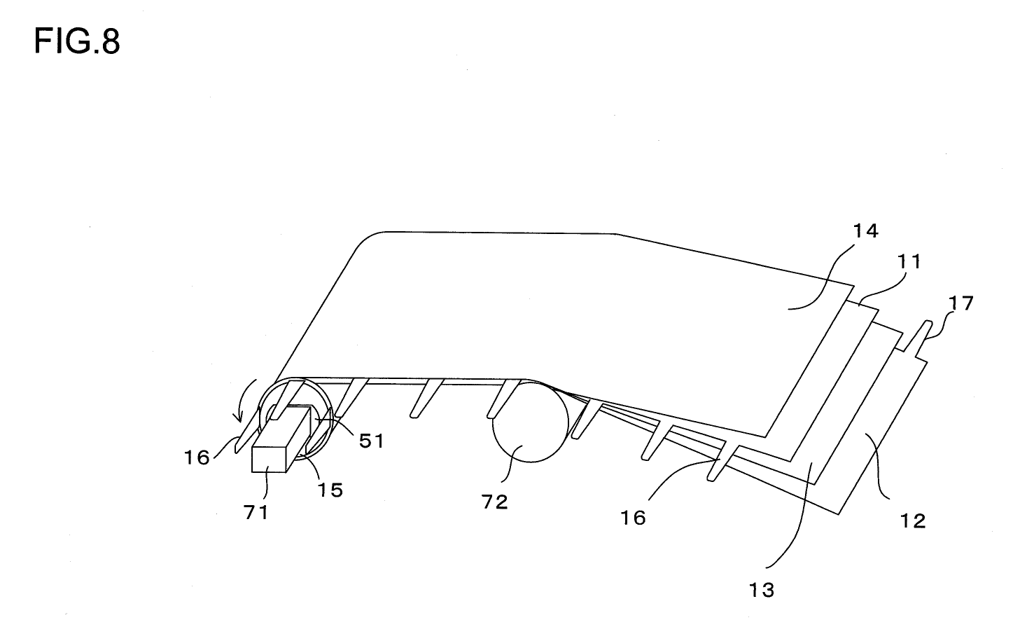

During the manufacture of the electrode group 10, a drive shaft of a winding device for rotationally driving the winding core 15 is fitted into the casing top end hollow portion 51 of the winding core 15. The double-dotted broken line 71 in FIG. 5 represents this drive shaft of the winding device (refer to FIG. 8). The width of this drive shaft 71 of the winding device is almost equal to the distance W_{N} between the two plane surfaces 53a and 53b of the casing top end hollow portion 51, and has only slight clearance against the tolerance of W_{N}. In other words, the two plane surfaces 53a and 53b of the casing top end hollow portion 51 of the winding core 15 function as a rotation reception and transmission unit by the drive shaft 71 of the winding device being fitted between them, and that is why the width of this drive shaft 71 of the winding device is almost equal to the distance W_{N} between the two plane surfaces 53a and 53b of the casing top end hollow portion 51, and is slightly smaller than the distance W_{N} so that only a small clearance is maintained.

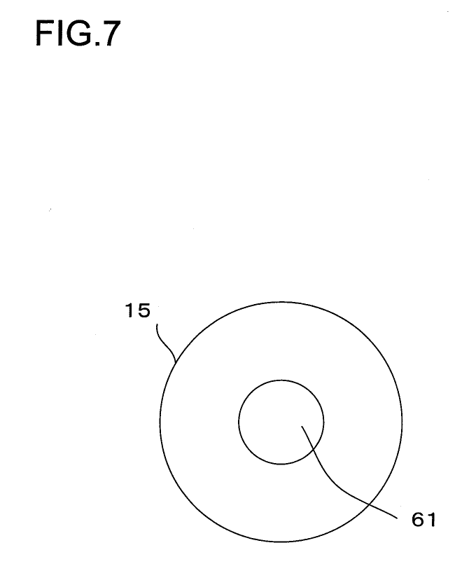

Moreover, as shown in FIG. 7, in a cross section orthogonal to its axial direction, the casing bottom end hollow portion 61 is shaped as a circle, so that overall it has the shape of a hollow circular cylinder. This casing bottom end hollow portion 61 also has a central axis that is coincident with the central axis of the external circumferential surface of the winding core 15. In other words, the casing top end hollow portion 51 and the casing bottom end hollow portion 61 are coaxial. And the diameter D of the circular cross sectional shape of the casing bottom end hollow portion 61 is smaller than the distance W_{N} between the two plane surfaces 53a and 53b of the casing top end hollow portion 51 of the winding core 15. In other words, the relationship D<W_{N} holds. Although this will be described in more detail hereinafter, a welding electrode rod is inserted through this casing bottom end hollow portion 61 from the casing top end hollow portion 51, for electrically connecting by welding the negative electrode current collecting member 21 of the electrode group 10 to the bottom inner surface portion 2b of the battery cell casing 2 which functions as a negative electrode. The diameter D of the casing bottom end hollow portion 61 is slightly larger than the diameter of this welding electrode rod, so that the amount of clearance between the winding core 15 and the welding electrode rod is extremely small.

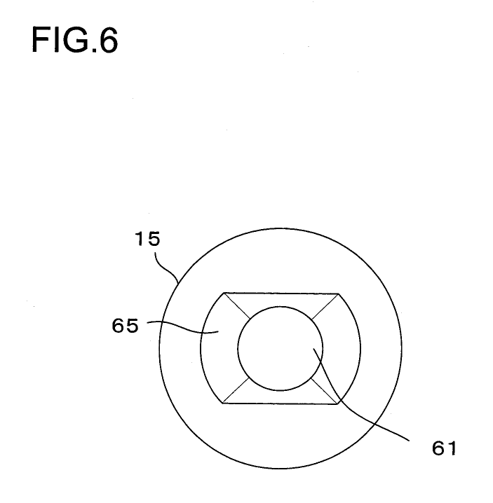

An intermediate hollow portion 65 is defined between the casing top end hollow portion 51 and the casing bottom end hollow portion 61. The shape and the size of the upper edge portion of this intermediate hollow portion 65 are the same as the shape and the size of the casing top end hollow portion 51, and the shape and the size of the lower edge portion of this intermediate hollow portion 65 are the same as the shape and the size of the casing bottom end hollow portion 61. And the cross sectional shape of this intermediate hollow portion 65 changes from a barrel shape to a circle from its upper edge portion towards its lower edge portion, while its sides slope so that its cross sectional size becomes gradually smaller. FIG. 6 is a sectional view of the FIG. 4 structure taken in a plane which is orthogonal to the axial direction and includes the line VI-VI, and, at the position of this section, the cross sectional size of the intermediate hollow portion 65 is intermediate between the cross sectional size of the casing top end hollow portion 51 shown in FIG. 5 and the cross sectional size of the casing bottom end hollow portion 61 shown in FIG. 7.

FIG. 8 is a perspective view showing a method for manufacture of the electrode group 10. The drive shaft 71 of the winding device (not shown in the drawings) is fitted into the casing top end hollow portion 51 of the winding core 15. As previously described, the drive shaft 71 is fitted in almost tightly between the two planes 53a and 53b of the casing top end hollow portion 51. The length of the drive shaft 71 that is fitted into the interior of the casing top end hollow portion 51 may be long enough to reach all the way to the vicinity of the upper edge of the intermediate hollow portion 65; or it could also be a shorter length that corresponds only to an upper end portion of the casing top end hollow portion 51.

The edges of the first separator 13 and the second separator 14 at their base ends along their lengthwise directions are overlapped upon the external peripheral surface of the winding core 15, and, in the state in which the edge of the first separator 13 is contacted to the external circumferential surface of the winding core 15, the end edges of the first separator 13 and the second separator 14 are welded to the winding core 15 (this feature is not shown in the drawing). The first separator 13 and the second separator 14 are wound up one or more turns upon the external circumferential surface of the winding core 15, and, after this winding up, the negative electrode 12 is tucked between the first separator 13 and the second separator 14 on the winding core 15. In this state, the winding core 15 is wound up through a predetermined angle. Next, the positive electrode 11 is sandwiched between the second separator 14 and the first separator 13. Then the second separator 14, the positive electrode 11, the first separator 13 and the negative electrode 12, which are layered in this order as shown in FIG. 8, are wound up together. At the end of winding, after winding of the second separator 14 and the positive electrode is completed, additionally the first separator 13 and the negative electrode 12 are wound up, by which as shown in FIG. 3, the negative electrode 14 comes to be positioned adjacent to the second separator 14 and on the outside thereof.

And, as shown in FIG. 8, the drive shaft 71 of the winding device is rotated in the anti-clockwise direction, and, while being guided by a guidance roller 72, the negative electrode 12, the second separator 14, the positive electrode 11, and the first separator 13 are wound onto the external circumferential surface of the winding core 15 in that order in a laminated state. At this time, as shown in FIG. 3, the winding is performed while adjusting the positions of the layer of negative electrode mixture 12b, the layer of positive electrode mixture 11b, the first separator 13, and the second separator 14 in the axial direction so that the relationship W_{S}>W_{C}>W_{A} is maintained.

In this process in which the winding core 15 is rotated and the electrodes and the separators are wound up, in the casing top end hollow portion 51 of the winding core 15 that has a barrel shaped cross section in its upper half portion in the axial direction, the distance W_{M} of the two curved surfaces 52a and 52b, whose cross sections are arch-shaped, of this barrel shaped casing top end hollow portion 51 and the distance W_{N} between the two parallel planes 53a and 53b that are provided to sandwich the two curved surfaces 52a and 52b as shown in FIG. 5 are both larger than the diameter D of the casing bottom end hollow portion 61. Due to this, it is possible to ensure that the rotational torque transmitted from the drive shaft 71 to the winding core 15 is sufficiently great.

Now, as described above, the negative electrode conducting lead 23, which is in a state that it is assembled as the electricity storage unit 20, is welded to the bottom inner surface portion 2b of the battery cell casing 2 by low resistance welding. In the following, this welding process will be explained. It should be noted that the assembly of the electricity storage unit will be explained later.

FIGS. 9 and 10 are enlarged sectional views showing the state in which the electricity storage unit 20 is contained within the battery cell casing 2, and in which low resistance welding is performed in order to weld the negative electrode conducting lead 23 to the bottom inner surface portion 2b of the battery cell casing 2. For performing this low resistance welding, as shown in FIGS. 9 and 10, a welding electrode rod 73 is inserted into the hollow portion of the winding core 15, the tip end portion of the welding electrode rod 73 is contacted against the negative electrode conducting lead 23, and an electrical current is flowed into the welding electrode rod 73 in this state in which the lower surface of the negative electrode conducting lead 23 is being contacted against the bottom inner surface portion 2b of the battery cell casing 2.

In this welding process, with the winding core 15 according to this embodiment in which the casing top end hollow portion 51 and the casing bottom end hollow portion 61 are formed, the welding electrode rod 73 is inserted into the casing top end hollow portion 51 through the opening portion 27d of the positive electrode current collecting member 27. At this time, in the casing top end hollow portion 51, both the distance W_{M} between the two curved surfaces52a and 52b of the casing top end hollow portion 51 and the distance W_{M} between its two planes 53a and 53b are larger than the diameter D of the casing bottom end hollow portion 61. Moreover, the circular arcs of the cross sections of the two curved surfaces 52a and 52b of the casing top end hollow portion 51 are coaxial with this casing bottom end hollow portion 61. Furthermore, as shown in FIG. 5, looking at the casing top end hollow portion 51 and the casing bottom end hollow portion 61 from along their mutual axis, the two planes 53a and 53b of the casing top end hollow portion 51 are arranged to sandwich the casing bottom end hollow portion 61 between them, and the distance between the planes 53a and 53b is greater than the diameter of the casing bottom end hollow portion 61. Due to this, it is possible to perform the insertion of the welding electrode rod 73 into the casing top end hollow portion 51 in a simple and easy manner with good efficiency. It should be understood that, in FIGS. 9 and 10, while the fitting portion 27b of the positive electrode current collecting member 27 is fitted into the tip end portion of the casing top end hollow portion 51, this fitting portion 27b is inserted in between the circular arcuate edge portions of the bulged outward portions 52 of the barrel shaped hollow portion 51, as shown by the dashed lines in FIG. 5. Due to this, the welding electrode rod 73 is not hampered when it is inserted into the casing top end hollow portion 51.

And the welding electrode rod 73 is pressed towards the bottom inner surface portion 2b of the battery cell casing 2. As described above, the diameter D of the casing bottom end hollow portion 61 is slightly larger than the diameter of the welding electrode rod 73, and the amount of clearance for the welding electrode rod 73 is extremely small. Due to this, directly inserting the welding electrode rod 73 into the casing bottom end hollow portion 61 of the winding core 15 would be a difficult task. However, according to the present invention, the intermediate hollow portion 65 is provided at the boundary between the casing top end hollow portion 51 and the casing bottom end hollow portion 61 of the winding core 15. And this intermediate hollow portion 65 gradually reduces in size from its upper edge portion to its lower edge portion, since it is made to be tapered. Due to this, the end of the welding electrode rod 73 can smoothly be inserted into the casing bottom end hollow portion 61, because it is guided by the sloping surface of the intermediate hollow portion 65.

And, as shown in FIG. 10, the end of the welding electrode rod 73 is contacted against the negative electrode conductive lead 23, and current is supplied via the welding electrode rod 73 in the state in which the negative electrode conductive lead 23 is being contacted against the bottom inner surface portion 2b of the battery cell casing 2, so that low resistance welding is performed. At this time it is possible to perform the welding reliably and easily, since the tolerance between the welding electrode rod 73 and the casing bottom end hollow portion 61 is extremely small and there is almost no clearance between them.

—Method for Manufacture of the Cylindrical Secondary Battery Cell—

Next, an example of a method for manufacture of the cylindrical secondary battery cell having the structure described above will be explained.

### <Manufacture of the Electrode Group>

First, the electrode group 10 is manufactured. The positive electrode 11 is manufactured by forming the layer of positive electrode mixture 11b and the positive electrode mixture uncovered portion 11c upon both sides of the positive electrode sheet 11a, and moreover by forming the large number of positive leads 16 integrally along one edge of the positive electrode sheet 11a. Similarly, the negative electrode 11 is manufactured by forming the layer of negative electrode mixture 12b and the negative electrode mixture uncovered portion 12c upon both sides of the negative electrode sheet 12a, and moreover by forming the large number of negative leads 17 integrally along one edge of the negative electrode sheet 12a.

And, as has been explained in relation to FIG. 8, the drive shaft 71 of the winding device (not shown in the drawings) is fitted into the casing top end hollow portion 51. Next, as described above, the drive shaft 71 is driven and the second separator 14, and the positive electrode 11, the first separator 13, the negative electrode 12 are laminated together and wound onto the external peripheral surface of the winding core 15 in that order. In this case, since the width of the casing top end hollow portion 51 is relatively large, a large rotational torque can be transmitted to the winding core 15, so that it is possible to suppose that a sufficient tension force can be applied during this winding of the second separator 14, and the positive electrode 11, the first separator 13, the negative electrode 12 onto the winding core 15. It should be understood that, as described above, the lengths of the electrodes and of the separators are adjusted so that the negative electrode 12 with the first separator 13 around it appear as the outermost layer of the winding core 15 with the separators and electrodes completely wound up thereupon. The tape 19 is then stuck around the external surface of the first separator on the outside of the coiled bundle, and thereby the manufacture of the electrode group 10 is completed.

—Manufacture of the Electricity Storage Unit—

Next, the electricity storage unit 20 is manufactured using this electrode group 10 that has been produced in the manner described above. First, the negative electrode current collecting member is attached to the lower portion of the electrode group 10. This attaching of the negative electrode current collecting member 21 is performed by fitting the opening portion 21b of the negative electrode current collecting member 21 over the stepped portion 69 that is provided upon the lower end portion of the winding core 15. Next, the negative leads 17 of the negative electrode 12 are allocated almost evenly along the entire external peripheral surface of the outer cylinder portion 21c of the negative electrode current collecting member 21 and the pressure member 22 is fitted over the outside of these negative leads 17 so that these negative leads adhere to the negative electrode current collecting member 21. And the negative leads 17 and the pressure member 22 are welded to the negative electrode current collecting member 21 by ultrasonic welding or the like. Next, the negative electrode conducting lead 23 is laid so as to straddle the lower end surface of the winding core 15 and the negative electrode current collecting member 21, and is welded to the negative electrode current collecting member 21.

And next, the fitting portion 27b of the positive electrode current collecting member 27 is fitted into the two curved surfaces 52a and 52b of the barrel shaped hollow portion 51 of the casing top end hollow portion 51 of the winding core 15. And the positive leads 16 of the positive electrode 11 are allocated almost evenly along the entire external peripheral surface of the upper cylinder portion 27c of the positive electrode current collecting member 27, and the pressure member 28 is fitted over the outside of these positive leads 16 so that these positive leads adhere to the positive electrode current collecting member. And then the positive leads 16 and the pressure member 28 are welded to the upper cylinder portion 27c of the positive electrode current collecting member 27 by ultrasonic welding or the like. The manufacture of the electricity storage unit 20 is completed in this manner (refer to FIG. 2).

—Loading the Electricity Storage Unit into the Battery Cell Casing—

Next, the electricity storage unit 20 is loaded into the battery cell casing 2. The electricity storage unit 20 that has been manufactured according to the process described above is fitted into a cylindrical member made from metal having a bottom, and that is of a size capable of containing the electricity storage unit 20. This cylindrical member made from metal having a bottom thus becomes the battery cell casing 2. In the following, in order to make the explanation simple and clear, this cylindrical member made from metal having a bottom will be described as being the battery cell casing 2.

—Welding the Negative Electrode—

Next, the negative electrode side of the electricity storage unit 20 is welded to the battery cell casing 2. The negative electrode conducting lead 23 of the electricity storage unit 20 stored in the battery casing 2 is now welded by low resistance welding or the like to the bottom inner surface portion 2b of the battery cell casing 2. As shown in FIG. 9, a welding electrode rod 73 is inserted into the opening portion 27d of the positive electrode current collecting member 27 and into the casing top end hollow portion 51 of the winding core 15. At this time, in the casing top end hollow portion 51, the distance W_{M} between the two curved surfaces 52a and 52b of the barrel shaped hollow portion 51 and the distance W_{N} between the two plane surfaces 53a and 53b are both larger than the diameter D of the casing bottom end hollow portion 61. Due to this, the insertion of the welding electrode rod 73 into the casing top end hollow portion 51 can be performed simply and easily with excellent efficiency.

And the welding electrode rod 73 is pushed towards the bottom inner surface portion 2b of the battery cell casing 2. At this time, the intermediate hollow portion 65 that is provided in the winding core 15 at the boundary between the casing top end hollow portion 51 and the casing bottom end hollow portion 61 guides the end of the welding electrode rod 73 along its tapered sloping surface, so that it can be inserted into the casing bottom end hollow portion 61 in a smooth manner. Although the diameter D of the casing bottom end hollow portion 61 is only slightly larger than the diameter of the welding electrode rod 73, nevertheless, in this manner, it is possible simply and easily to insert the welding electrode rod 73 into the casing bottom end hollow portion 61.

And, as shown in FIG. 10, in the state in which the end of the welding electrode rod 73 is contacted against the negative electrode conductive lead 23 and presses the negative electrode conductive lead 23 against the bottom inner surface portion 2b of the battery cell casing 2, an electrical current is supplied via the welding electrode rod 73, and low resistance welding is performed. At this time, since the tolerance between the welding electrode rod 73 and the casing bottom end hollow portion 61 is extremely small, accordingly there is almost no clearance between these two members, and due to this it is possible to perform the welding in a reliable manner.

Next, a portion of the upper end portion of the battery cell casing 2 is pushed inward by a spinning process, so as to form an almost V-shaped groove 2a on its outer surface. This groove 2a in the battery cell casing 2 is formed so as to be positioned in the neighborhood of the upper end portion of the electricity storage unit 20, or, to put it in another manner, in the neighborhood of the upper end portion of the positive electrode current collecting member 27. It should be understood that, as will be described hereinafter, the shape and the size of the groove 2a that is formed in this process are not its final shape or size, but are only a temporary shape and size.

—Injection of the Electrolyte—

Next, a predetermined amount of a non-aqueous electrolyte is injected into the interior of the battery cell casing 2 through the opening portion 27e of the positive electrode current collecting member 27. Examples of the composition for the non-aqueous electrolyte have been cited above.

—Manufacture of the Lid Unit—

On the other hand, the manufacture of the lid unit 30 is performed separately from the manufacture of the electricity generation unit and its loading into the battery cell casing 2. As previously described, the lid unit 30 includes the insulation plate 34, the connection plate 35 that is fitted into the opening portion 34a provided in the insulation plate 34, the diaphragm 37 that is welded to the connection plate 35, and the lid 3 that is fixed to the diaphragm 37 by swaging.

In the manufacture of this lid unit 30, first, the lid 3 is fixed to the diaphragm 37. This fixing together of the diaphragm 37 and the lid 3 is performed by swaging or the like. Since, as shown in FIG. 2, initially, the side wall 37b of the diaphragm 37 is formed to be perpendicular to its base portion 37a, accordingly the peripheral portion of the lid 3 is disposed within the side wall 37b of the diaphragm 37. And the side wall 37b of the diaphragm 37 is deformed by pressing or the like, so that it covers and is pressed into contact with the upper surface, the lower surface, and the external periphery of the lid 3.

Furthermore, the connection plate 35 is fitted into and attached to the opening portion 34a of the insulation plate 34. And the projecting portion 35a of the connection plate 35 is welded to the bottom surface of the diaphragm 37 to which the lid 3 has been fixed. The welding method employed in this case may be low resistance welding or friction stir welding. By the connection plate 35 and the diaphragm 37 being welded together, the insulation plate 34 into which the connection plate 35 has been fitted and the lid 3 to which the diaphragm 37 has been fixed are integrated together, and thereby the manufacture of the lid unit 30 is completed.

—Welding the Positive Electrode—

Next, the electricity storage unit 20 and the lid unit 30 are electrically connected together. One end portion of the connection member 45 is welded to the base portion 27a of the positive electrode current collecting member 27, for example by ultrasonic welding or the like. And the lid unit 3, in which the lid 3, the diaphragm 37, the connection plate 35 and the insulation plate 34 have been integrated together, is placed close to the other end portion of the connection member 45. Next, the other end portion of the connection member 45 is welded by laser welding to the lower surface of the connection plate 35. This welding is performed by ensuring that the welded surface at the other end portion of the connection member 45 to the connection plate 35 becomes the same surface as the welded surface of the one end portion of the connection member 45 that is welded to the positive electrode current collecting member 27.

—Sealing the Battery Cell—

Next, the battery cell casing 2 is sealed by fixing to the battery cell casing 2 the lid unit 30, that has thus been electrically connected to the positive electrode current collecting member 27 of the electricity storage unit 20 that is loaded into the battery cell casing 2. The gasket 43 is loaded above the groove 2a of the battery cell casing 2. In this state, as shown in FIG. 2, the gasket 43 has a configuration in which the external peripheral wall portion 43b extends upwards perpendicularly from the annular base portion 43a. With this structure, the gasket 43 is received within the battery cell casing 2, above the groove 2a. The gasket 43 is made from rubber, although this is not intended to be limitative; as one suitable material, for example, ethylene propylene diene monomer rubber (EPDM) may be suggested. Furthermore, for example, if the battery cell casing 2 is made from carbon steel and has thickness 0.5 mm and external diameter of 40 mm, then the thickness of the gasket 43 may be around 1 mm.

Next the lid unit 30, that is electrically connected to the positive electrode current collecting member 27 of the electricity storage unit 20, is arranged above the cylinder portion 43c of the gasket 43. In more detail, the diaphragm 37 of the lid unit 30 is mounted upon the gasket 43 so that its peripheral portion corresponds to the cylinder portion 43c thereof. At this time, it is ensured that the upper cylinder portion 27c of the positive electrode current collecting member 27 is fitted into the external peripheral surface of the side portion 34b of the insulation plate 34.

In this state, by so called swaging processing in which the groove 2a of the battery cell casing 2 and the portion between the groove 2a and the upper end surface of the battery cell casing 2 are compressed by pressure, the diaphragm 37 is fixed to the battery cell casing 2 together with the gasket 43. Due to this the lid unit 30, in which the diaphragm 37, the lid 3, the connection plate 35, and the insulation plate 34 have been integrated together, is fixed to the battery cell casing 2 with the gasket 43 intervening between them, and moreover the lid 3 and the positive electrode current collecting member 27 are connected together via the connection member 45 the connection plate 35, and the diaphragm 37 so that electricity can be conducted between them; and thereby the manufacture of the cylindrical battery cell 1 shown in FIG. 1 is completed.

According to the above process, in this secondary battery cell according to the present invention, the winding core 15 has the structure described that includes the casing top end hollow portion 51 and the casing bottom end hollow portion 61. And the upper surface and the cross sectional shape of the casing top end hollow portion 51 have the two curved surfaces 52a and 52b whose cross sections are circular arcs, and have the two plane surfaces 53a and 53b sandwiching these two curved surfaces. Moreover, the two planes 53a and 53b of the casing top end hollow portion constitute a rotation reception and transmission unit, into which the drive shaft 71 of the winding device is fitted. And the casing bottom end hollow portion 61 constitutes a guide portion to the member to be welded, into which the welding electrode rod 73 is inserted. The diameter D of the casing bottom end hollow portion 61 is only slightly larger than the diameter of the welding electrode rod 73, so that there is almost no clearance between it and the welding electrode rod 73. And the distance W_{M} between the two curved surfaces 52a and 52b of the casing top end hollow portion 51 and the distance W_{N} between the two planes 53a and 53b are both larger than the diameter D of the casing bottom end hollow portion 61.

Due to this structure, it becomes possible to make the drive shaft 71 of the winding device that is inserted into the casing top end hollow portion 51 large in width, so that it is possible to rotate the winding core 15 with a large rotational torque. Moreover, since there is almost no clearance between the casing bottom end hollow portion 61 and the welding electrode rod 73, accordingly it is possible to perform the welding of the negative electrode conductive lead 23 to the bottom inner surface portion 2b of the battery cell casing 2 in a reliable manner. Furthermore, the structure includes the tapered intermediate hollow portion 65 between the casing top end hollow portion 51 and the casing bottom end hollow portion 61 that has a tapered sloping surface whose cross section diminishes gradually from the casing top end hollow portion 51 down towards the casing bottom end hollow portion 61. Due to this, the advantageous effect is obtained that it is simple and easy to pass the welding electrode rod 73 through the intermediate hollow portion 65 and into the casing bottom end hollow portion 61, even though the tolerance between the welding electrode rod 73 and the casing bottom end hollow portion 61 is very tight. It should be understood that the structure of the winding core 15 is not to be considered as being limited to that explained for the first embodiment as described above; various alterations are possible. In the following, other embodiments will be explained.

### Embodiment 2

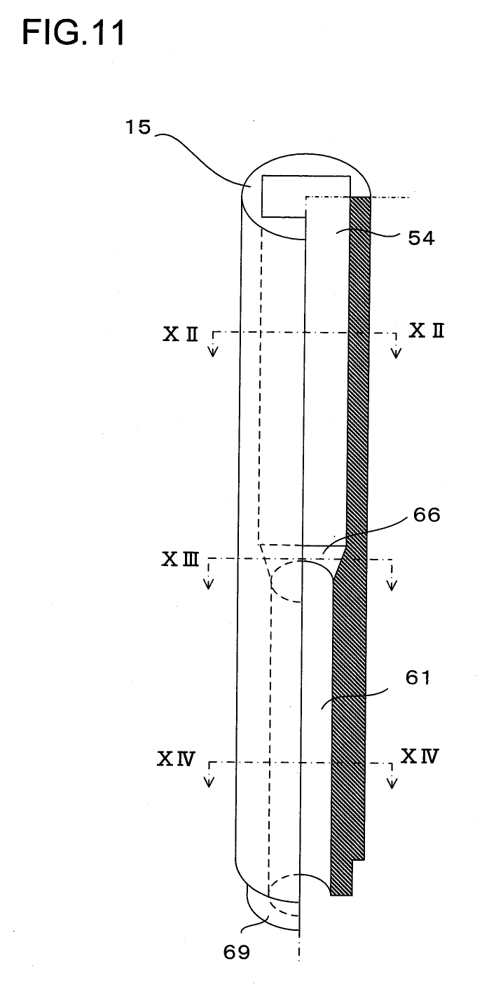

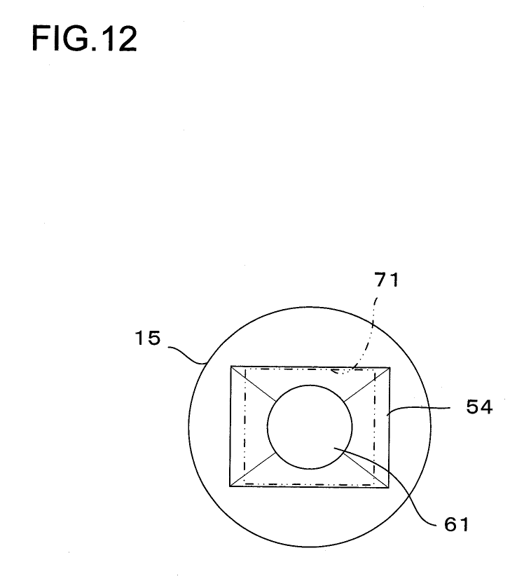

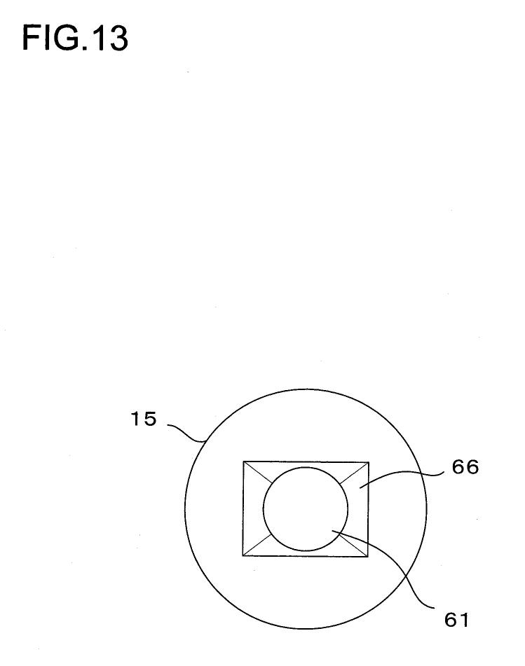

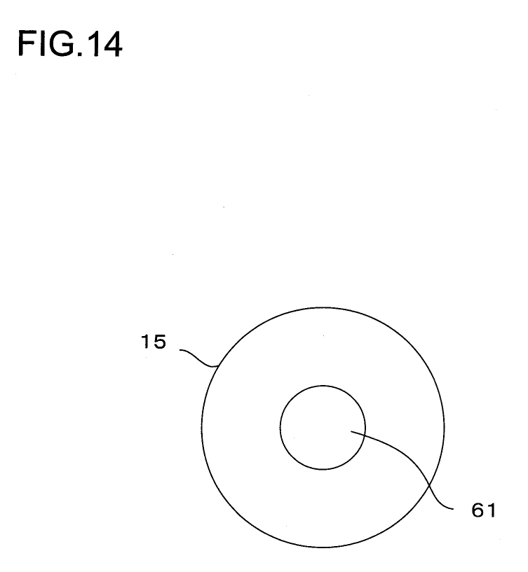

FIGS. 11 through 14 show a second embodiment of the winding core of the secondary battery cell according to the present invention. FIG. 11 is a magnified sectional view of the winding core in a state with a portion thereof cut away along its axial direction by two mutually orthogonal planes that contain its axis. And FIGS. 12, 13, and 14 are enlarged sectional views of the FIG. 11 structure taken in planes which are orthogonal to the axial direction and respectively include the line XII-XII, the line XIII-XIII, and the line XIV-XIV.

In a similar manner to the case with the first embodiment, the winding core 15 of this second embodiment has a casing top end hollow portion 54, a casing bottom end hollow portion 61, and an intermediate hollow portion 66. The casing bottom end hollow portion 61 is the same as in the first embodiment and constitutes a guide portion for the welding member (i.e. the electrode rod 73), and has almost the same diameter as the welding electrode rod 73 so that almost no clearance remains when the rod is inserted thereinto.

The aspect in which the winding core 15 according to this second embodiment differs from that of the first embodiment, is that the shape of the upper end plane surface of the casing top end hollow portion 54 and its cross sectional shape in a section orthogonal to its central axis are rectangular. As shown in FIG. 12, the width and the length of the upper end surface of the casing top end hollow portion 54 and the width and the length of its cross sectional shape are all greater than the diameter of the casing bottom end hollow portion 61. At its upper end portion, the intermediate hollow portion 66 has the same cross sectional shape and size as the casing top end hollow portion 54, while at its lower end portion it has the same cross sectional shape and size as the casing bottom end hollow portion 61. Moreover, the cross sectional shape of its region intermediate between its upper end portion and its lower end portion changes, downwards from the upper end portion to the lower end portion, gradually and smoothly from a rectangle to a circle, and also its cross sectional size becomes progressively smaller downwards, so that this portion is tapered downwards.

As shown by the double-dotted broken line in FIG. 12, the drive shaft 71 of the winding device is inserted into the casing top end hollow portion 54 which has a large cross section with a little gap between the drive shaft 71 and the hollow portion 54. Due to this, with this winding core 15 according to the second embodiment as well, it is possible to transmit a large rotational torque to the winding core 15 with the drive shaft 71 of the winding device. Moreover, since the shape of the intermediate hollow portion 66 is smoothly changed to become the circular shape of the cross section of the casing bottom end hollow portion 61 as in the case of the first embodiment, accordingly the same advantageous effect that a welding electrode rod for welding the negative electrode is easily inserted is obtained as with that first embodiment.

### Embodiment 3

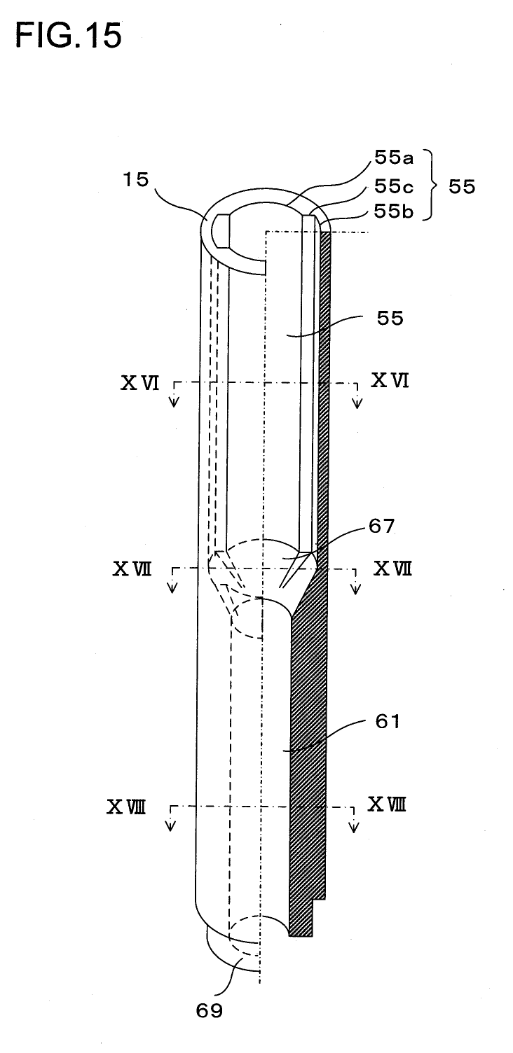

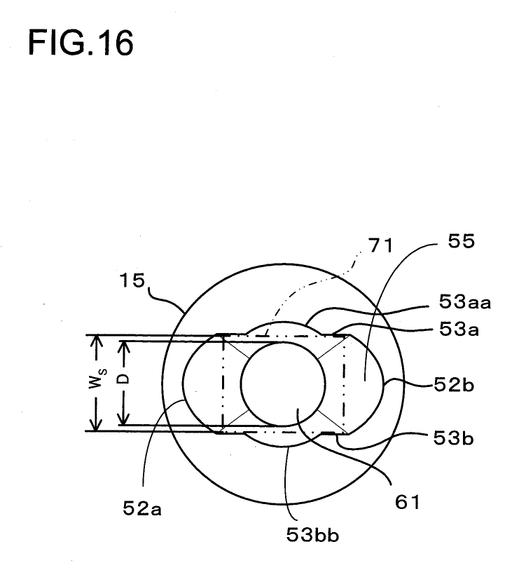

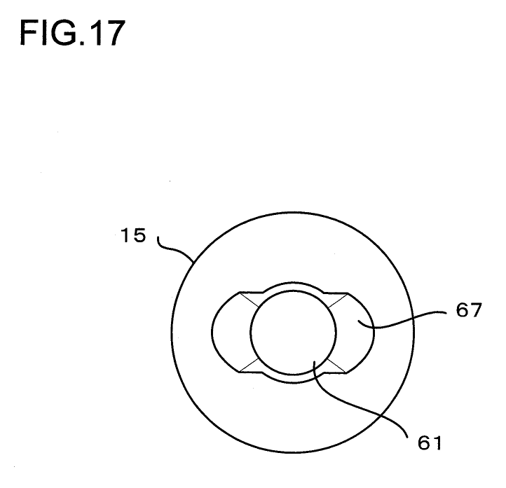

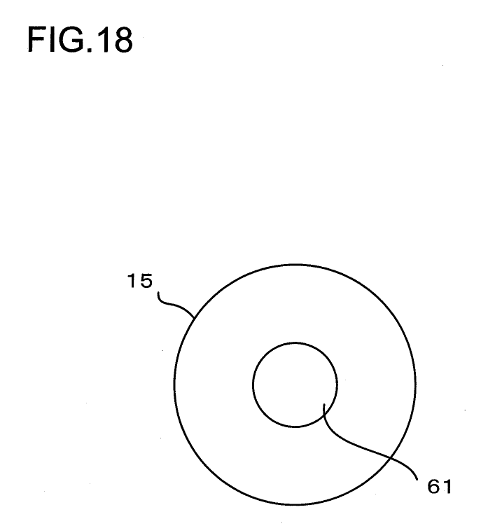

FIGS. 15 through 18 show a third embodiment of the winding core of the secondary battery cell according to the present invention. FIG. 15 is a magnified sectional view of the winding core in a state with a portion thereof cut away along its axial direction by two mutually orthogonal planes that contain its axis. And FIGS. 16, 17, and 18 are enlarged sectional views of the FIG. 15 structure taken in planes which are orthogonal to the axial direction and respectively include the line XVI-XII, the line XVII-XVII, and the line XVIII-XVIII. It should be understood that, to portions that correspond to portions in FIGS. 5 and 6, the same reference symbols are appended.

In a similar manner to the case with the first embodiment, the winding core 15 of this third embodiment has a casing top end hollow portion 55, a casing bottom end hollow portion 61, and an intermediate hollow portion 67. The casing bottom end hollow portion 61 is the same as in the first embodiment and constitutes a guide portion for the welding member (i.e. the electrode rod 73), and has almost the same diameter as the welding electrode rod 73 so that almost no clearance remains when the rod is inserted thereinto.

The aspect in which the winding core 15 according to this third embodiment differs from those of the first and second embodiments, is related to the shape of the upper end plane surface of the casing top end hollow portion 55 and to its cross sectional shape in a section orthogonal to its central axis. In the shape of the upper end plane surface of the casing top end hollow portion 55 and its cross sectional shape, the casing top end hollow portion 51 having the barrel shaped cross section shown in FIG. 5 is modified by each of its two planes 53a and 53b now having one of two respective curved surfaces 53aa and 53bb that are shaped as mutually coaxial circular arcs having a diameter larger than that of the casing bottom end hollow portion 61. Further, the two curved surfaces 52a and 52b may be elliptical.

While in this casing top end hollow portion 55, as shown in FIG. 16, the space between the two planes 53a and 53b is W_{S} that is smaller than W_{N} in FIG. 5, even this width W_{S} is slightly larger than the diameter D of the casing bottom end hollow portion 61. At its upper end portion, the intermediate hollow portion 67 has the same cross sectional shape and size as the casing top end hollow portion 55, while at its lower end portion it has the same cross sectional shape and size as the casing bottom end hollow portion 61. Moreover, the cross sectional shape of its region intermediate between its upper end portion and its lower end portion changes, downwards from the upper end portion to the lower end portion, gradually and smoothly from the compound shape described above to a circle, and also its cross sectional size becomes progressively smaller downwards, so that this portion is tapered downwards.

As shown by the double-dotted broken line in FIG. 16, the drive shaft 71 of the winding device is inserted into the casing top end hollow portion 55 between the two planes 53a and 53b with a slight gap. Due to this, with this winding core 15 according to the third embodiment as well, it is possible to transmit a large rotational torque to the winding core 15 with the drive shaft 71 of the winding device. Moreover, since the casing bottom end hollow portion 61 and the intermediate hollow portion 67 are the same as in the case of the first embodiment, accordingly the same advantageous effects are obtained as with that first embodiment.

### Embodiment 4

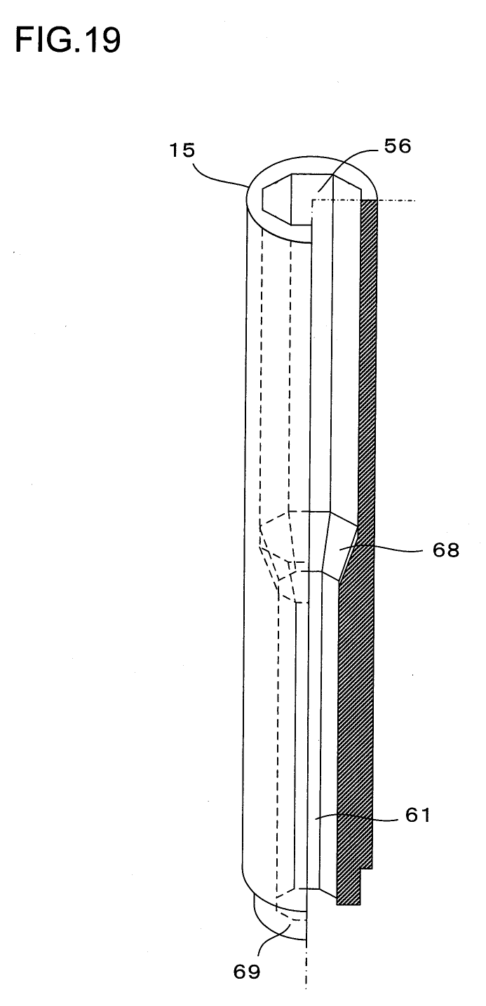

FIG. 19 shows a fourth embodiment of the winding core of the secondary battery cell according to the present invention. In the first through the third embodiments, the vertical length and the horizontal length of the upper planar surface of the casing top end hollow portion and of its cross section were different. By contrast, the distinguishing feature of the winding core 15 of this fourth embodiment is that the vertical length and the horizontal length of the upper planar surface of the casing top end hollow portion 56 are the same, and similarly the vertical length and the horizontal length of its cross section are the same. In other words, the shape of the upper planar surface of the casing top end hollow portion 56 of the winding core 15 shown in FIG. 19 is a regular octagon circumscribing a circle which is coaxial with the casing bottom end hollow portion. And the diameter of a circle inscribed in the cross sectional shape, a regular octagon, of the casing top end hollow portion 56 is larger than the diameter of the casing bottom end hollow portion 61.

And, at its upper end portion, the intermediate hollow portion 68 has the same cross sectional shape and size as the casing top end hollow portion 56, while at its lower end portion it has the same cross sectional shape and size as the casing bottom end hollow portion 61. Moreover, the cross sectional shape of its region intermediate between its upper end portion and its lower end portion changes gradually and smoothly downwards from the upper end portion to the lower end portion, and also its cross sectional size becomes progressively smaller downwards, so that this portion is tapered downwards. With this winding core 15 according to the fourth embodiment, it will be appropriate for the drive shaft 71 of the winding device to have an octagonal cross sectional shape that is the same as that of the upper planar surface of the casing top end hollow portion 56 (but slightly smaller, of course); or, alternatively, it may have a rectangular shape that is appropriate for fitting into opposing corners of the octagonal shape of the casing top end hollow portion 56.

Accordingly, with this winding core 15 according to the fourth embodiment as well, it is possible to transmit a large rotational torque to the winding core 15 with the drive shaft 71 of the winding device. Moreover, since and the shape of the intermediate hollow portion 68 is smoothly changed to become the circular shape of the cross section of the casing bottom end hollow portion 61 as in the case of the first embodiment, accordingly the same advantageous effect that a welding electrode rod for welding the negative electrode is easily inserted is obtained as with that first embodiment.

While, in this fourth embodiment, an example has been shown in which the cross sectional shape of the casing top end hollow portion 56 was a regular octagon, this is not intended to be limitative of the cross sectional shape of the casing top end hollow portion 56; it could be a square, a regular hexagon, or a polygon having more sides than eight.

### Embodiment 5

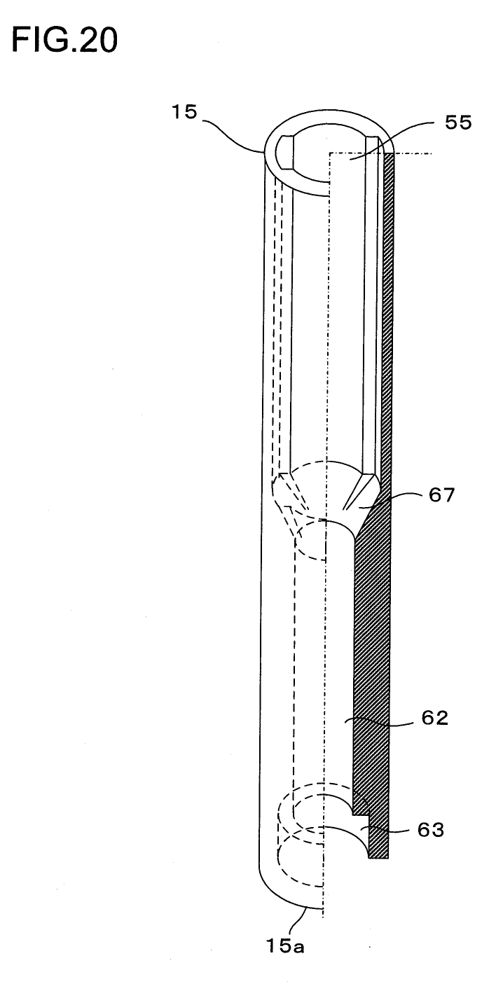

With the winding cores 15 of all of the first through the fourth embodiments, the construction is such that the lower end surface of the hollow portion for guidance, into which is inserted the welding electrode rod 73 that is the member for performing welding, is coincident with the lower surface of the winding core 15. However, the first distinguishing feature of the winding core 15 of the fifth embodiment of the present invention shown by way of example in FIG. 20 is that the hollow portion for guiding the member for welding (i.e. the welding rod) is an intermediate portion of the winding core 15 in its axial direction.

Furthermore with the winding cores 15 of all of the first through the fourth embodiments, a construction was adopted in which the stepped portion 69 having a smaller external diameter than the external diameter of the winding core 15 on the external circumference of the lower end portion of the winding core 15, and the negative electrode current collecting member 21 was fitted over this stepped portion 69. However, the second distinguishing feature of the winding core 15 of this fifth embodiment shown by way of example in FIG. 20 is that a stepped portion is formed in the hollow portion of the winding core 15, with the negative electrode current collecting member 21 being fitted into this stepped portion.

In detail, the winding core 15 shown in FIG. 20 has a casing top end hollow portion 55 and an intermediate hollow portion 67 similar to those of the winding core 15 shown in FIG. 15. And the cross sectional shapes of the casing top end hollow portion 55 and the intermediate hollow portion 67 are the same as in the case of the third embodiment shown in FIG. 15. Moreover, in a similar manner to the case with the third embodiment, there is provided a casing bottom end hollow portion 62 for guiding the welding electrode rod 73. However, with this winding core 15 of the fifth embodiment shown by way of example, the lower end surface of the casing bottom end hollow portion 62 does not coincide with the lower surface 15a of the winding core 15, but is spaced apart therefrom. Thus, a radially enlarged portion 63 of a predetermined height from the lower surface 15a of the winding core 15 is provided. As shown in the figure, this radially enlarged portion 63 has a diameter that is larger than the diameter of the casing bottom end hollow portion 62. And, while this feature is not shown in the drawing, a small barrel portion that is provided at the central portion of the negative electrode current collecting member 21 is adapted to be fitted into this radially enlarged portion 63, thus attaching the negative electrode current collecting member 21 to the winding core 15.

In this manner, even though the construction is such that the lower end surface of the casing bottom end hollow portion 62 into which the welding electrode rod 73 is inserted does not reach the lower surface 15a of the winding core 15, if the diameter of this casing bottom end hollow portion 62 is only slightly larger than the diameter of the welding electrode rod 73 so that there is almost no clearance between these two members, then it is still possible to perform welding reliably with the welding electrode rod 73. Accordingly, with this fifth embodiment of the present invention as well, it is possible to obtain the same advantageous effects as in the case of the first embodiment.

It should be understood that the distance from the lower surface 15a of the winding core 15 to the lower end surface of the casing bottom end hollow portion 62 may be set to be larger than in the case shown in FIG. 20; it is only necessary for the length of the casing top end hollow portion 62 to be sufficiently long for it to be able reliably to support and position the welding electrode rod 73, so that welding can be performed properly. Moreover while, in this fifth embodiment, the shape of the casing top end hollow portion 55 was, by way of example, made to be the same as in the case of the third embodiment, this is not intended to be limitative of the present invention; a shape as in one of the other disclosed embodiments may be freely employed for this casing top end hollow portion.

### Embodiment 6

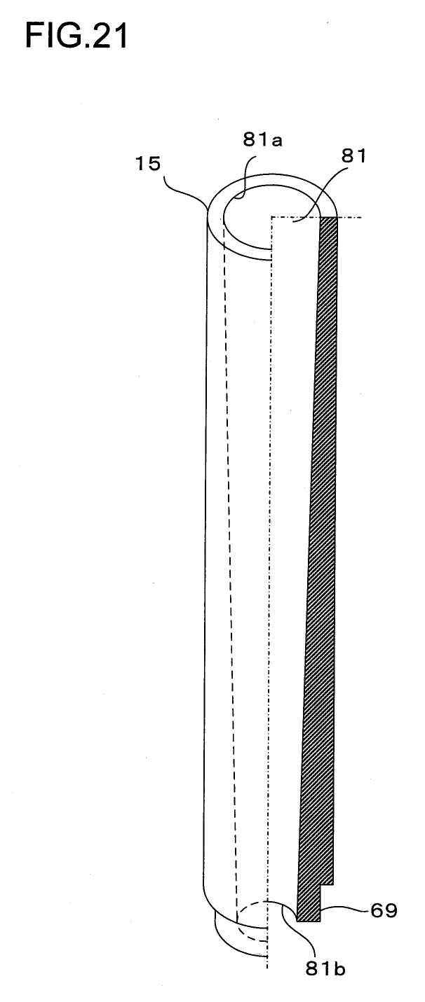

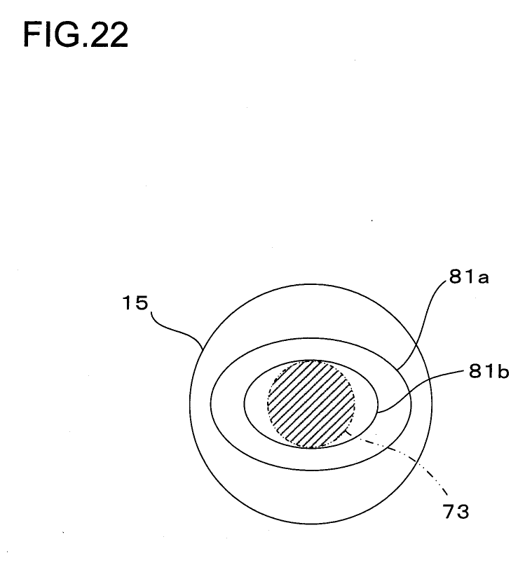

FIG. 21 is an enlarged sectional view showing a sixth embodiment of the winding core of the secondary battery cell according to the present invention, in a state with a portion thereof cut away along its axial direction by two mutually orthogonal planes that contain its axis, and FIG. 22 is a plan view thereof. In this embodiment, a hollow portion 81 of the winding core 15 is shaped as a frustum, which has an elliptical cross section from the top portion of the hollow portion 81 to the bottom of the hollow portion 81. In other words, as shown in FIG. 22, the center of the ellipse at the top end of this hollow portion 81 and the center of ellipse at the bottom end of this hollow portion 81 are coincident with the central axis of the winding core 15. And the size of the elliptical portion 81a at the top end of the hollow portion 81 is larger than the size of the elliptical portion 81b at the bottom end of the hollow portion 81.

The size of circular portion 81b at the bottom end of the hollow portion 81 is slightly larger than the diameter of the welding electrode rod 73. In this case, it is appropriate for the drive shaft of the winding device for rotationally driving the winding core 15 to have a shape that can be fitted with only small clearance into the above frustum-shaped hollow portion 81 from its top end portion. Or, it may have a polygonal shape such as a rectangular shape or the like, provided that its size is intermediate between the sizes of similar polygons inscribed in the elliptical portions 81a and 81b. In this sixth embodiment as well, the rotation reception and transmission unit into which the drive shaft of the winding device is fitted is larger than the diameter of the welding electrode rod 73, and also, when the welding electrode rod 73 is passed through the hollow portion 81, it is supported well by the elliptical portion 81b at the lower surface of the hollow portion 81, since there is almost no clearance between them. Accordingly, the same advantageous effects may be obtained as in the case of the first embodiment.

It should be understood that, in this sixth embodiment, the hollow portion 81 is made as a tapered sloping surface over its entire extent, from its upper end surface to its lower end surface; but it would also be acceptable to arrange for sections thereof, down to a predetermined depth from its upper end surface and up to a predetermined height from its lower end surface, to be made as sections extending parallel to the central axis of the winding core 15, i.e., to put it in another manner, for an upper section thereof and a lower section thereof to be formed as vertical.

Furthermore, though, in this 6th embodiment, the lower end surface of the hollow portion 81 is assumed to be an ellipse having a miner axis of length larger than the diameter of the welding electrode rod, it is more desirable to assume a circular shape for the shape of the lower end surface of the hollow end portion 81, by which the play between the hollow portion 81 and the inserted welding electrode rod is made to be minimum. In addition, it would also be acceptable to arrange for the lower section, i.e. the section up to a predetermined height from its lower end surface, to be made with a circular cross section. In this case, the transition from the circular cross section of the lower section of the hollow portion 81 to the elliptical cross section of the upper section of the hollow portion 81 should be made smoothly.

With the secondary battery cell according to the present invention described in the above 1st through 6th embodiments, it is possible to perform welding in an accurate manner, since the size of the casing bottom end hollow portion that is provided to the winding core 15 is made to be almost the same as the external size of the welding electrode rod 73, so that there is a very slight clearance between them. Furthermore it is possible to rotate the winding core 15 with a large rotational torque, since even at its minimum width the casing top end hollow portion has a size that is greater than that of the casing bottom end hollow portion. Moreover, since it is possible to insert the welding electrode rod 73 from the casing top end hollow portion into the casing bottom end hollow portion in a smooth manner due to the provision of the tapered sloping surface between these two portions, down which the end of the welding electrode rod 73 slides smoothly, accordingly the advantageous effect is obtained that it is possible also to perform the process of insertion of the welding electrode rod 73 with good efficiency.

It should be understood that, in the first through the sixth embodiments described above, cases have been explained in which the connection between the negative electrode 12 and the battery cell casing 2 was performed by welding the negative electrode conducting lead 23 to the bottom inner surface portion 2b of the battery cell casing 2. However, it would also be acceptable not to provide any opening portion 21b in the central portion of the negative electrode current collecting member 21, and to arrange to weld the negative electrode current collecting member 21 directly to the bottom inner surface portion 2b of the battery cell casing 2.

Moreover, it would also be possible to make the cross sectional shape of the casing bottom end hollow portion of the winding core 15 not circular or elliptical, but polygonal. Yet further, the cross section of the welding electrode rod 73 is not limited to being circular; the present invention could also be applied to the case of a welding rod whose cross section is elliptical or polygonal.

While in the embodiments described above cases have been explained in which the electrode that was welded to the battery cell casing 2 was the negative electrode 12, this is not to be considered as being limitative; it would also be possible to apply the present invention to a case in which the positive electrode 11 is welded to the battery cell casing 2. Furthermore, cases have been explained in which the present invention is applied to a secondary battery cell that is a cylindrical lithium ion battery cell that uses a non-aqueous electrolyte. However, the present invention could also be applied to a secondary battery cell that uses a water-soluble electrolyte, such as a nickel-hydrogen battery or a nickel-cadmium battery or the like.

Furthermore, while the secondary battery cell according to the present invention can be altered in various different ways within its scope, it may be defined as being a secondary battery cell including: an electricity storage unit that includes a winding core having a hollow portion pierced along its central portion in an axial direction, a positive electrode and a negative electrode that are wound around the outer circumferential surface of the winding core, and an electrolyte; and a battery cell container within which the electricity storage unit is contained; and wherein the cross sectional shape of the hollow portion of the winding core orthogonal to its axis is larger at one position along that axis than at another position along that axis.

In the embodiments described above, a construction was employed in which an electrode group in which a positive electrode, a negative electrode, and separators were superimposed over one another and were wound upon a winding core. If the dimensions of the external shape of the winding core are small, then, in the manufacturing process of winding the electrode group upon the winding core, a state is set up in which stress is concentrated upon certain areas etc., and this is not desirable from the point of view of durability and so on. Furthermore, in the manufacturing process described above, it is desirable to wind the electrode group upon the winding core while applying an appropriate tension, and accordingly it is desirable to employ the method of forming a hollow portion in the winding core, fitting a rotatable drive shaft of a winding device into this hollow portion, and thereby rotating the winding core while maintaining an appropriate state of tension upon the electrode group. It is desirable to make this hollow portion of the winding core large enough in order to fit the above described drive shaft of the winding device into it.

On the other hand, if a welding rod is to be inserted and contacted for welding by utilizing a hollow portion of the winding core, then the inner diameter of the hollow portion of the winding core is made to be only slightly larger than the diameter of the welding electrode rod that is to be used for welding. With this arrangement in which the inner diameter of the lower hollow portion of the winding core is only slightly larger than the diameter of the welding electrode rod, this hollow portion of the winding core serves the important function of guiding the welding rod, and also operates to locate the position of the welding rod during welding. By thus positionally determining the welding electrode rod for performing welding, it is possible to solve problems during welding such as partial contact due to tilting of the welding electrode rod and so on, and accordingly it becomes possible greatly to enhance the reliability of the welding.

According to the embodiments described above, by making the hollow portion of the winding core that is positioned towards where welding is to be performed (i.e. its lower portion) of smaller diameter, while on the other hand making the hollow portion of the winding core that is positioned towards the opposite side thereof to be of larger diameter, it is possible to insert the welding electrode rod in a simple and easy manner, and moreover it becomes possible to perform positional determination of the welding electrode rod for welding. Due to this, the reliability of the manufacturing process is enhanced. Furthermore, it is possible to fit the drive shaft of the winding device appropriately into the radially larger hollow portion of the winding core, according to requirements. Moreover it is possible to wind the electrode group up on the winding core while maintaining an appropriate state of tension, and this is linked to enhancement of the reliability.

Since, according to the embodiments described above, in the embodiments 1 through 5, the larger diameter upper portion of the hollow portion of the winding core is made in a shape that has two mutually opposing planar surfaces, and in the 6th embodiment the larger diameter upper portion of the hollow portion of the winding core has a cross section of larger ellipse, accordingly it is possible to transmit the rotational torque of the drive shaft of the winding device to the winding core in a simple manner via these two planar surfaces. And on the other hand, by making the smaller diameter lower portion of the hollow portion of the winding core as circular, it becomes particularly suitable for positional determination of the welding electrode rod during the welding process. Thus, by changing the internal shape and size of the hollow portion of the winding core along its axial length in this manned between the upper hollow portion whose cross section is large and the lower hollow portion whose cross section is small, it is possible to enhance the productivity of the manufacturing process with a simple shape, and also it is possible to enhance the reliability of the welding process.

Further, accordingly, it should be acceptable that the electricity storage unit 20 is installed with the arrangement that the smaller diameter portion of the hollow portion of the winding core is positioned at the top of the cell casing 2, for positioning the welding electrode rod 73. However, in this case, it is desirable to form a spot facing on the end surface of the smaller diameter portion of the hollow portion of the winding core. With such a spot facing, the welding electrode rode is inserted into the winding core easily.

In the embodiments described above, in order to make the portion into which the drive shaft of the above described winding device is fitted for transmission of rotational torque larger, the length along the axial direction of the winding core of the above described larger diameter upper hollow portion may desirably be increased to around half of the total length. In any case, for appropriately transmission of the rotational torque, it is desirable to utilize one third of the length or more.

It should be noted that the present invention is not limited to the above explained embodiment. In order to put the present invention into practice, it is only needed that the hollow portion of the winding core has a cross section larger than the cross section of a welding electrode rod 73 on one side, and a cross section on another side by which the welding electrode rod 73 is smoothly guided with almost no clearance. Further the shape of the cross section of the hollow portion is not limited to a circle.

Thus the side of the hollow portion (that corresponds to the portion with reference number 61), which positions an inserted welding electrode with almost no clearance, should have only such a structure by which the welding electrode rod 73 is inserted with almost no clearance. For example, if a welding electrode rod 73 has a circular cross section, then the cross section of the hollow portion needs only to have a shape with which the electrode rod 73 is contacted at 3 points. For such a structure, the cross section shape of the hollow portion is not necessarily be a circle, but also it may be a triangle, a polygon with more corners, or any complex shape with curved lines. Further, an equivalent effect for positioning may be obtained, when the electrode rode is contacted with more than 2 protruding portions which are formed at the inner surface of the hollow portion. In addition, if a welding electrode rod has a rectangular cross section, then it is clear that the hollow portion needs to have a similar positioning structure corresponding to the cross section shape of the welding electrode rod. For positioning a welding electrode rod with rectangular cross section, it may be necessary to provide more than 3 protruding portion at the inner surface of the hollow portion which contact to the welding electrode rod at more than 3 points, or it may be also accepted that the welding electrode is contacted to the hollow portion at one corner of the rectangular cross section of the welding electrode rod and at two other points with protruding portions provided in the inner surface of the hollow portion. In the latter case, by contacting with three points, the welding electrode rod may be positioned.

The another side of the hollow portion (that corresponds to the portion with reference number 51, 54, or 55), into which a drive shaft of a winding machine is inserted, needs only to have a cross section shape larger than that of a welding electrode rod, by which the welding electrode rod is inserted smoothly. Therefore, the cross section shape of the hollow portion does not need to be a circular shape, but also it may have a triangular or a polygonal shape, or any complex shape with curved lines. However, an intermediate hollow portion (that corresponds to the portion with reference number 65, 66, 67 or 68) connecting the side of the hollow portion (that corresponds to the portion with reference number 51, 54, 55, or 56), into which the drive shaft of the winding machine is inserted, and the side of the hollow portion (that corresponds to the portion with reference number 65, 66, 67, or 68), which positions an inserted welding electrode with almost no clearance, should have a structure by which a welding electrode rod is smoothly inserted into the side of the hollow portion for positioning the welding electrode rod, when the welding electrode rod is inserted from the side of the hollow portion for inserting the drive shaft of the winding machine. Thus, as explained above, the cross section shape of the intermediate hollow portion is not limited to such a shape as its shape smoothly changes from that of the hollow portion for inserting the drive shaft of the winding machine to that of the hollow portion for positioning the welding electrode rod. For example, if a welding electrode rod with circular cross section is inserted, the intermediate hollow portion needs to have such a structure that more than 2 protruding portions are provided with substantially equal distance to each other at the inner surface of the intermediate hollow portion in its circumferential direction, and that the distance between these protruding portions are smoothly narrowed along the direction to the side of hollow portion for positioning the welding electrode rod. Further, in a case where a welding electrode rod with rectangular cross section is used, similarly as explained, a structure with more than 3 protruding portions, or a structure with one groove which fits to one corner of the welding electrode rod and two protruding portions which contact to two sides of the rectangular welding electrode rod, opposing to the corner fitted to the groove.

While various embodiments and variant embodiments have been explained above, the present invention is not to be considered as being limited by the details thereof. Other possibilities that may be considered to lie within the scope of the technical concept of the present invention are also included within the range of the present invention.

1. A secondary battery cell, comprising:
an electricity storage unit that comprises a winding core having a hollow portion pierced along its central portion in an axial direction, a positive electrode and a negative electrode that are wound around the outer circumferential surface of the winding core, an electrolyte, a positive current collecting member and a negative current collecting member; and a battery cell container within which the electricity storage unit is contained;
and wherein the cross sectional shape of the hollow portion of the winding core orthogonal to its axis is larger at one side along that axis than at another side along that axis.

2. A secondary battery cell, comprising an electricity storage unit including a winding core having a hollow portion pierced along its central portion in an axial direction, a positive electrode and a negative electrode and a separator between the positive electrode and the negative electrode that are wound around of the winding core on its outer circumferential surface, and a positive current collecting member provided on one side of the winding core and a negative current collecting member provided on another side the winding core in its axial direction and respectively connected to the positive electrode or to the negative electrode, and a battery cell container that contains the electricity storage unit;
and wherein:
the positive current collecting member and the negative current collecting member are welded to the battery cell container directly or indirectly via some other member and thereby electrically connected thereto; and
the hollow portion of the winding core has a larger cross section orthogonal to the axial direction of the winding core at its welded side where either the positive current collecting member or the negative current collecting member is welded than at another side where neither the negative current collecting member nor the positive current collecting member is welded.

3. A secondary battery cell according to claim 1, wherein:
the cross section of the hollow portion of the winding core orthogonal to its axial direction at the one side is larger than that at the another side; and
a joining portion is provided that smoothly joins between the one side of the hollow portion of the winding core and the another side thereof.

4. A secondary battery cell according to claim 3, wherein the cross section of the hollow portion of the winding core orthogonal to its axial direction, at the one side of the hollow portion of the winding core, has a shape including a rectilinear portion as at least a portion thereof.

5. A secondary battery cell according to claim 3, wherein:
the battery cell container comprises a cell casing, which has a cylindrical shape with an opening at one end and a bottom at the other end, and a lid;
the cell casing is assumed to be a negative electrode;
the electricity storage unit is cylindrical;
the electricity storage unit has a positive lead that is provided nearer to the lid of the battery cell container, and a negative lead that is provide nearer to the bottom of the cell casing of the battery cell container;
the cross section of the hollow portion of the winding core orthogonal to its axial direction nearer to the lid is larger than the cross section of the hollow portion of the winding core orthogonal to its axis nearer to the bottom of the cell casing;
the positive current collecting member and the negative current collecting member are provided to the winding core respectively near the lid side of the winding core and near the bottom side of the cell casing; and
the positive current collecting member on the lid side has a fixing portion, and the positive current collecting member on the lid side is fixed to the winding core by the fixing portion being fitted into the hollow portion of the winding core at the lid side.

6. A secondary battery cell according to claim 5, wherein the negative current collecting member near the bottom side of the cell casing has a fixing portion, and the negative current collecting member is fixed to the winding core at the bottom side of the cell casing by the fixing portion being fitted to the winding core on its bottom end portion external circumference.

7. A secondary battery cell according to claim 2, wherein:
the cross section of the hollow portion of the winding core orthogonal to its axial direction at the one side is larger than that at the another side; and
a joining portion is provided that smoothly joins between the one side of the hollow portion of the winding core and the another side thereof.

8. A secondary battery cell according to claim 7, wherein the cross section of the hollow portion of the winding core orthogonal to its axial direction, at the one side of the hollow portion of the winding core, has a shape including a rectilinear portion as at least a portion thereof.

9. A secondary battery cell according to claim 7, wherein:
the battery cell container comprises a cell casing, which has a cylindrical shape with an opening at one end and a bottom at the other end, and a lid;
the cell casing is assumed to be a negative electrode;
the electricity storage unit is cylindrical;
the electricity storage unit has a positive lead that is provided nearer to the lid of the battery cell container, and a negative lead that is provide nearer to the bottom of the cell casing of the battery cell container;
the cross section of the hollow portion of the winding core orthogonal to its axial direction nearer to the lid is larger than the cross section of the hollow portion of the winding core orthogonal to its axis nearer to the bottom of the cell casing;
the positive current collecting member and the negative current collecting member are provided to the winding core respectively near the lid side of the winding core and near the bottom side of the cell casing; and
the positive current collecting member on the lid side has a fixing portion, and the positive current collecting member on the lid side is fixed to the winding core by the fixing portion being fitted into the hollow portion of the winding core at the lid side.

10. A secondary battery cell according to claim 9, wherein the negative current collecting member near the bottom side of the cell casing has a fixing portion, and the negative current collecting member is fixed to the winding core at the bottom side of the cell casing by the fixing portion being fitted to the winding core on its bottom end portion external circumference.
